(19) United States
(12) Patent Application Publication
(10) Pub. No.: US 2024/0329319 A1
(43) Pub. Date: Oct. 3, 2024

(54) OPTICAL MODULE

(71) Applicant: SUMITOMO ELECTRIC INDUSTRIES, LTD., Osaka (JP)

(72) Inventors: Hiroshi UEMURA, Osaka (JP); Keiji TANAKA, Osaka (JP)

(21) Appl. No.: 18/611,993

(22) Filed: Mar. 21, 2024

(30) Foreign Application Priority Data
Mar. 29, 2023 (JP) 2023-053299

(51) Int. Cl. G02B 6/30

(52) U.S. Cl. CPC G02B 6/30

(57) ABSTRACT

An optical module according to one embodiment includes a substrate made of glass and having a first surface, a second surface opposite to the first surface, a via penetrating between the first surface and the second surface, and a first waveguide provided between the first surface and the second surface; an optical element that is mounted on the first surface, and that inputs and outputs an optical signal; a thermally conductive member mounted on the second surface and thermally connected to the optical element through the via; and a second waveguide provided on the first surface. The optical signal is input to and output from an outside through the second waveguide and the first waveguide.

### CROSS-REFERENCE TO RELATED APPLICATION

This application claims priority from Japanese Patent Application No. 2023-053299, filed on Mar. 29, 2023, the entire subject matter of which is incorporated herein by reference.

### TECHNICAL FIELD

The present disclosure relates to an optical module.

### BACKGROUND

Japanese Unexamined Patent Publication No. 2021-173875 describes an optical module. The optical module includes a housing having an internal space; optical components accommodated in the internal space of the housing; and a lid that seals the internal space of the housing. The housing is airtightly sealed by closing an opening thereof with the lid. The optical components include a light source, an optical transmitter circuit, an optical receiver circuit, a high-speed large-scale integration (LSI), a heat sink block, and a Peltier element. The heat sink block is a cooling component that cools the high-speed LSI. The Peltier element is a cooling component that cools the light source, the optical transmitter circuit, and the optical receiver circuit. The Peltier element is airtightly sealed inside the housing, together with the optical transmitter circuit and the optical receiver circuit.

Japanese Unexamined Patent Publication No. 2020-086389 describes optical components. The optical components include a housing; a wiring formed on the housing; an optical circuit element disposed inside the housing; a mount for mounting the optical circuit element; a wiring substrate; and a lid. The optical components are flip-chip mounted on the external wiring substrate. The optical circuit element includes an optical circuit formed of an optical waveguide. A portion of the optical circuit which is responsible for photoelectric conversion and electro-optical conversion is connected to the wiring by connecting means such as a bonding wire. Since the housing is sealed by the lid, moisture and the like are prevented from entering the inside of the housing. A temperature control element may be disposed instead of the mount, and in this case, the temperature control element is sealed together with the optical circuit.

A thermoelectric cooler integrated with IHS on a FC-PBGA package, which is presented by Chih-Kuang Yu, Chun-Kai Liu, Ming-Ji Dai, Sheng-Liang Kuo, and Chung-Yen Hsu in the 2007 26th International Conference on Thermoelectrics, includes a ball grid array (BGA) substrate; a chip mounted on the BGA substrate; a thermoelectric cooler (TEC) mounted on the chip; and a housing that accommodates the chip and the TEC. An upper surface (circuit surface) of the chip is flip-chip mounted on the BGA substrate. A lower surface (substrate surface) of the chip is connected to an integrated heat spreader (IHS) through the TEC. The chip is pressed from above and below by the BGA substrate and the TEC.

### SUMMARY

An optical module according to the present disclosure includes a substrate made of glass and having a first surface, a second surface opposite to the first surface, a via penetrating between the first surface and the second surface, and a first waveguide provided between the first surface and the second surface; an optical element that is mounted on the first surface, and that inputs and outputs an optical signal; a thermally conductive member mounted on the second surface and thermally connected to the optical element through the via; and a second waveguide provided on the first surface. The optical signal is input to and output from an outside through the second waveguide and the first waveguide.

### BRIEF DESCRIPTION OF THE DRAWINGS

FIG. 1 is a cross-sectional view showing an optical module according to an embodiment.

FIG. 2 is a plan view schematically showing the optical module of FIG. 1.

FIG. 3 is a view showing a first waveguide and a second waveguide.

FIG. 4 is a view showing the first waveguide and the second waveguide.

FIG. 5 is a view showing the first waveguide and an optical fiber.

FIG. 6 is a cross-sectional view showing an optical module according to a first modification example.

FIG. 7 is a view showing a first waveguide and a second waveguide according to a second modification example.

FIG. 8 is a view showing a first waveguide and a second waveguide according to a third modification example.

FIG. 9 is a view showing a first waveguide and a second waveguide according to a fourth modification example.

FIG. 10 is a view showing a first waveguide and a second waveguide according to a fifth modification example.

FIG. 11 is a view showing a first waveguide and a second waveguide according to a sixth modification example.

FIG. 12 is a cross-sectional view showing an optical module according to a seventh modification example.

FIG. 13 is a cross-sectional view showing an optical module according to an eighth modification example.

FIG. 14 is a cross-sectional view showing an optical module according to a ninth modification example.

FIG. 15 is a cross-sectional view showing an optical module according to a tenth modification example.

FIG. 16 is a view showing a second lens of the optical module of FIG. 15.

FIG. 17 is a cross-sectional view showing an optical module according to an eleventh modification example.

FIG. 18 is a partially enlarged view of the optical module of FIG. 17.

FIG. 19 is a cross-sectional view showing an optical module according to a twelfth modification example.

FIG. 20 is a cross-sectional view showing an optical module according to a thirteenth modification example.

FIG. 21 is a cross-sectional view showing an optical module according to a fourteenth modification example.

FIG. 22 is a cross-sectional view showing an optical module according to a fifteenth modification example.

### DETAILED DESCRIPTION

By the way, an optical element mounted on the wiring substrate may be disposed in a narrow space. In addition, since the optical element may be affected by heat, the dissipation of heat therefrom is required. Therefore, even when the optical element is disposed in the narrow space, it is required to appropriately perform the dissipation of heat and the input and output of an optical signal.

An object of the present disclosure is to provide an optical module that appropriately performs the dissipation of heat from an optical element and the input and output of an optical signal.

According to the present disclosure, it is possible to appropriately perform the dissipation of heat from the optical element and the input and output of the optical signal.

### Description of Embodiment of Present Disclosure

First, an embodiment of an optical module according to the present disclosure will be listed and described. An optical module according to one embodiment includes a substrate made of glass and having a first surface, a second surface opposite to the first surface, a via penetrating between the first surface and the second surface, and a first waveguide provided between the first surface and the second surface; an optical element that is mounted on the first surface, and that inputs and outputs an optical signal; a thermally conductive member mounted on the second surface and thermally connected to the optical element through the via; and a second waveguide provided on the first surface. The optical signal is input to and output from an outside through the second waveguide and the first waveguide.

The optical module includes the substrate made of glass and having the first surface, the second surface, and the via; the optical element; and the thermally conductive member. The optical element is mounted on the first surface of the substrate, and the thermally conductive member is provided on the second surface opposite to the first surface. The thermally conductive member provided on the second surface is thermally connected to the optical element through the via. Therefore, since heat generated from the optical element is released from the substrate through the via and the thermally conductive member, the heat can be dissipated from the optical element. The first waveguide is provided between the first surface and the second surface of the substrate, and the second waveguide is provided on the first surface of the substrate. The optical signal is input to and output from the outside of the optical module through the second waveguide and the first waveguide. Therefore, since the optical element is optically coupled to the outside of the optical module through the second waveguide and the first waveguide, the input and output of the optical signal can be appropriately performed.

(2) In the above (1), the first surface of the substrate may include a recessed portion. The optical element may be mounted in the recessed portion, and the second waveguide may be provided in the recessed portion. In this case, the thickness of the optical module can be suppressed by mounting the optical element in the recessed portion and providing the second waveguide in the recessed portion.

(3) In the above (2), the substrate may extend in a first direction and a second direction intersecting the first direction, and may have a thickness in a third direction intersecting both the first direction and the second direction. The second waveguide may be optically coupled to the first waveguide through an inner surface of the recessed portion, and the inner surface may be inclined with respect to the second direction. In this case, the reflection of the optical signal on the inner surface can be suppressed.

(4) In the above (2), the substrate may extend in a first direction and a second direction intersecting the first direction, and may have a thickness in a third direction intersecting both the first direction and the second direction. The second waveguide may be optically coupled to the first waveguide through an inner surface of the recessed portion, and the inner surface may be inclined with respect to the third direction. In this case, the reflection of the optical signal on the inner surface can be suppressed.

(5) In any of the above (2) to (4), the second waveguide may be optically coupled to the first waveguide through an inner surface of the recessed portion, and an anti-reflection film may be provided on the inner surface. In this case, the reflection of the optical signal on the inner surface can be suppressed.

(6) In any of the above (1) to (5), the second waveguide may be evanescently coupled to the first waveguide.

(7) In any of the above (1) to (6), the optical module may further include an optical fiber, and the first waveguide may be optically coupled between the second waveguide and the optical fiber.

(8) In any of the above (1) to (7), the first waveguide may penetrate between the first surface and the second surface.

(9) An optical module according to another embodiment includes a substrate made of glass and having a first surface, a second surface opposite to the first surface, a via penetrating between the first surface and the second surface, and a first waveguide provided between the first surface and the second surface; an optical element that is mounted on the first surface, and that inputs and outputs an optical signal; and a thermally conductive member mounted on the second surface and thermally connected to the optical element through the via. The substrate extends in a first direction and a second direction intersecting the first direction, and has a thickness in a third direction intersecting both the first direction and the second direction. The optical element includes a first lens having an optical axis parallel to the first direction. The substrate includes a second lens optically coupled to the first lens. The optical signal is input to and output from an outside through the first lens, the second lens, and the first waveguide.

The optical module includes the substrate made of glass and having the first surface, the second surface, and the via; the optical element, and the thermally conductive member, and the optical element is mounted on the first surface of the substrate. The thermally conductive member provided on the second surface is thermally connected to the optical element through the via. Therefore, since heat generated from the optical element is released from the substrate through the via and the thermally conductive member, the heat can be dissipated from the optical element. The second lens is provided on the substrate, and the first lens optically coupled to the second lens is provided on the optical element. The optical signal is input to and output from the outside of the optical module through the first lens, the second lens, and the first waveguide. Therefore, since the optical element is optically coupled to the outside of the optical module through the first lens, the second lens, and the first waveguide, the input and output of the optical signal can be appropriately performed.

### Details of Embodiment of Present Disclosure

Various examples of optical modules according to an embodiment will be described below with reference to the drawings. Incidentally, it is intended that the present invention is not limited to the following examples and includes all changes implied by the claims and within the scope equivalent to the claims. In the description of the drawings, the same or corresponding elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

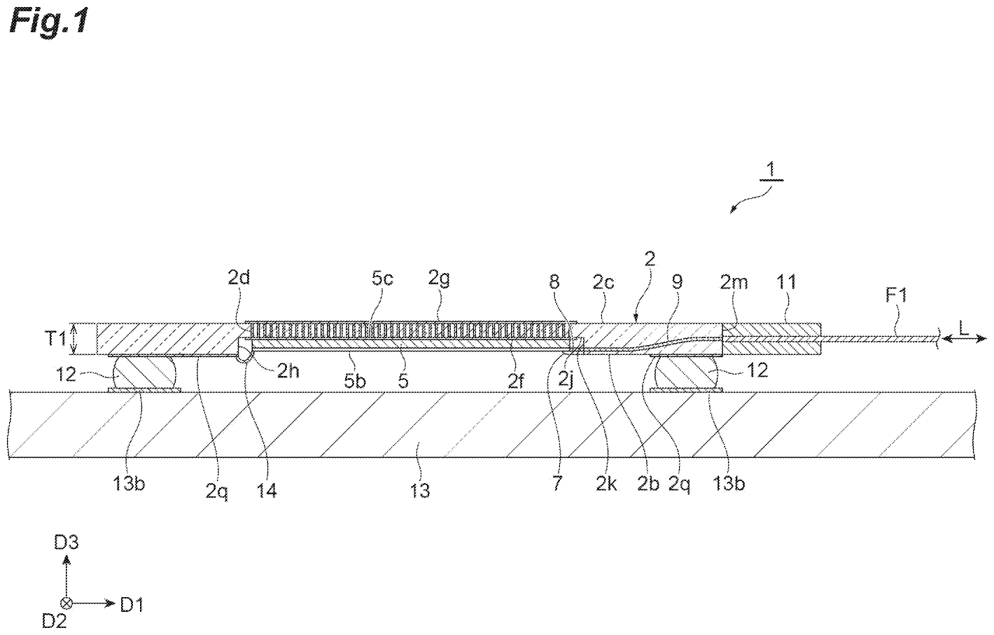

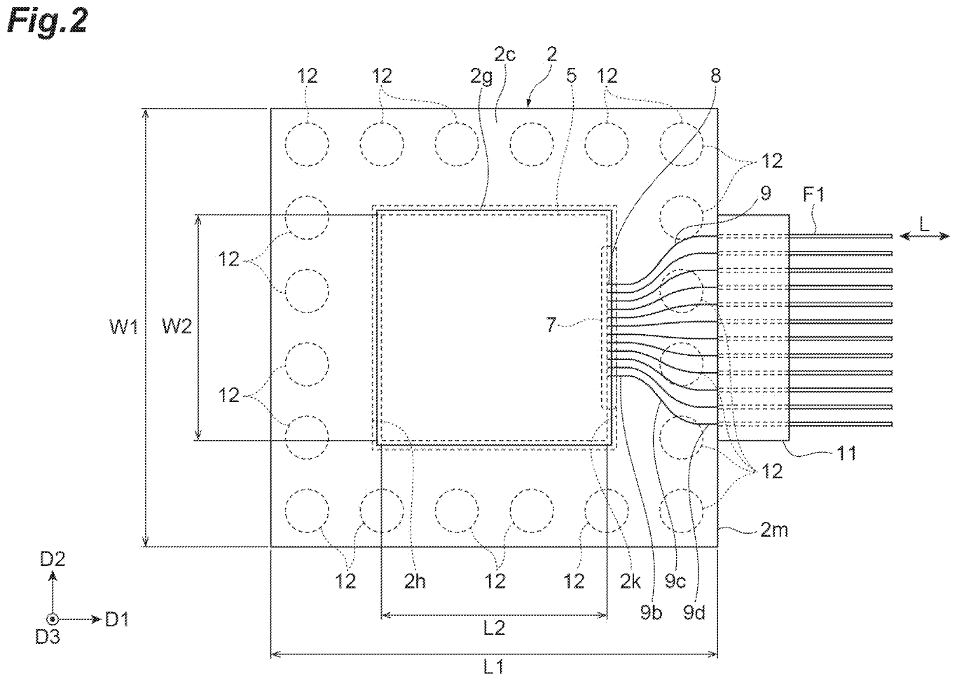

FIG. 1 is a cross-sectional view showing an optical module 1 according to the present embodiment. FIG. 2 is a plan view schematically showing the optical module 1. As shown in FIGS. 1 and 2, the optical module 1 includes a substrate 2 and an optical element 5. The optical module 1 is, for example, an optical transmitter module that converts an electrical signal into an optical signal to transmit the optical signal to the outside. For example, the optical module 1 is a coherent optical transmitter module used for digital coherent optical transmission.

The substrate 2 is made of glass. For example, the substrate 2 is a glass interposer. The substrate 2 extends in a first direction D1 and a second direction D2 intersecting the first direction D1. The substrate 2 has a thickness in a third direction D3 intersecting both the first direction D1 and the second direction D2. As one example, a length L1 of the substrate 2 in the first direction D1 is 5 mm, and a length W1 of the substrate 2 in the second direction D2 is 5 mm. A length T1 of the substrate 2 in the third direction D3 (thickness of the substrate 2) is, for example, 0.5 mm.

The substrate 2 is made of, for example, one of soda lime glass, borosilicate glass, crystallized glass, and quartz glass. For example, a main component of the glass constituting the substrate 2 is silicon dioxide (SiO₂). The substrate 2 may be a composite containing at least one of sodium (Na) and calcium (Ca). A linear expansion coefficient of the substrate 2 is, for example, 3 to 5 [ppm/K]. However, the linear expansion coefficient of the substrate 2 can be set to 1 [ppm/K] or less, or approximately 10 [ppm/K] by adjusting the composition of materials constituting the glass. The difference between the linear expansion coefficient of the substrate 2 and a linear expansion coefficient of the optical element 5 to be described later may be small. By setting the difference in linear expansion coefficient to be small, stress caused by expansion and contraction due to a change in temperature can be reduced, and the reliability of the optical element 5 can be improved.

The substrate 2 has a first surface 2b; a second surface 2c opposite to the first surface 2b; and a via 2d penetrating between the first surface 2b and the second surface 2c. Since the via 2d is formed in the substrate 2 to penetrate between the first surface 2b and the second surface 2c, the via 2d is also referred to as a through glass via (TGV). The via 2d has, for example, a columnar shape extending along the third direction D3.

A diameter of the via 2d when viewed along the third direction D3 (in a plan view) is, for example, 100 μm. A length (thickness) of the via 2d in the third direction D3 is, for example, 300 μm. In a cross section of the via 2d along the third direction D3, an angle of a boundary line between the via 2d and the glass surrounding the via 2d (a portion of the substrate 2 other than the via 2d) is not limited to being perpendicular to the first surface 2b, and may be inclined with respect to the first surface 2b. In such a manner, the via 2d may extend in such a manner as to incline in the first direction D1 or the second direction D2 with respect to the first surface 2b. The shape of the via 2d in a cross section perpendicular to the first surface 2b may become thinner or thicker from the first surface 2btoward the second surface 2c. In addition, the shape may become thinner from the first surface 2b toward a center of the substrate 2 in the third direction D3, and then become thicker from the center toward the second surface 2c. The diameter of the via 2d represents the maximum value of the diameter in a cross section where the cross-sectional shape of the via 2d is a circular shape. When the cross-sectional shape of the via 2d is an elliptical shape, the diameter of the via 2d represents a length of the major axis (major diameter).

The substrate 2 includes a plurality of the vias 2d. The plurality of vias 2d are aligned, for example, along each of the first direction D1 and the second direction D2. For example, in a plan view of the substrate 2, the vias 2d are two-dimensionally arranged at a constant pitch. A pitch of the vias 2d (distance from a central axis of one via 2d to a central axis of the via 2d adjacent to the via 2d) is, for example, 250 μm.

The first surface 2b is a surface on which the optical element 5 is mounted. The first surface 2b extends in both the first direction D1 and the second direction D2. The second surface 2c faces a side opposite to the first surface 2b, and extends in both the first direction D1 and the second direction D2. The vias 2d extend from the first surface 2b to the second surface 2c along the third direction D3. The vias 2d are filled with, for example, metal (also referred to as filled vias).

The vias 2d have a thermal conductivity higher than a thermal conductivity of the substrate 2 (a thermal conductivity of the glass portion of the substrate 2 other than the vias 2d), and are thermally connected to the optical element 5. The vias 2d function as thermal conduction paths, and transfer heat, for example, which is generated from the optical element 5, more efficiently than the glass material constituting the substrate 2. The vias 2d are also referred to as thermal vias since the vias 2d are used for the purpose of thermal conduction. Incidentally, the vias 2d can also be used for the purpose of electrical conduction.

As a specific example, the vias 2d are filled with copper (Cu). The copper with which the vias 2d are filled comes into close contact with the surrounding glass portion (the portion of the substrate 2 other than the vias 2d), thereby ensuring the airtightness of the substrate 2 between the first surface 2b and the second surface 2c. For example, a leakage amount of the substrate 2, in which the vias 2d are formed, according to a fine leakage test is less than 1.0×10⁻⁹ [Pa·m³/s]. Since the copper has good thermal conductivity, when the vias 2d are filled with the copper, the vias 2d can function as thermal vias.

A thermal conductivity of the copper (Cu) is approximately 400 [W/(m·K)]. Therefore, when the individual area and density of the vias 2d are adjusted such that an in-plane density of the vias 2d (the ratio of the copper in the plurality of vias 2d to the glass portion of the substrate 2 when viewed along the third direction D3) is 10%, even in a case where the thermal conductivity of the glass portion is estimated to be almost zero which is lower than an actual value, the thermal conductivity of the portion of the vias 2d (corresponding to thermal pads to be described later) is approximately 40 [W/(m·K)] on average.

An example in which the vias 2d are made of copper has been described above. However, the vias 2d may be filled with a semiconductor. As a specific example, the vias 2d may be filled with silicon (Si). Since a linear expansion coefficient of Si is approximately 3 to 4 [ppm/K], a linear expansion coefficient of Cu is approximately 18 [ppm/K], and a linear expansion coefficient of glass is, for example, approximately 3 to 5 [ppm/K], when the vias 2d are filled with Si, the difference in linear expansion coefficient between the vias 2d and the surrounding glass portion is smaller compared to when the vias 2d are filled with Cu. For this reason, for example, stress caused by a change in temperature can be reduced. By reducing the stress, the diameter of the vias 2d can be increased compared to when the vias 2d are filled with Cu. A thermal conductivity of Si is approximately 160 [W/(m·K)], and is lower than the thermal conductivity of Cu. However, by increasing the areas of the vias 2d, the ratio of the total area of the vias 2d to the area of the glass portion of the substrate 2 can be increased, and the thermal conductivity of the portion of the vias 2d can be improved.

Incidentally, the vias 2d may be formed as a single via having the same shape and approximately the same area as electrodes 2g and 2f functioning as thermal pads to be described later. The inside of the single via may be filled with Si. The shape of the single via in a plan view of the substrate 2 may be a rectangular shape. In order to suppress stress concentration, the four corners of the rectangular via may be rounded.

For example, the electrodes 2f and 2g are thin films made of copper. A thickness of the electrodes 2f and 2g is, for example, 1 μm or more and 10 μm or less, and is, as one example, 5 μm. The surfaces of the electrodes 2f and 2g are plated with, for example, gold (Au). For example, the electrodes 2f and 2g may be formed by plating nickel (Ni) or palladium (Pd) between gold plating and copper. For example, the electrodes 2f and 2g are pads (thermal pads) that cover the plurality of vias 2d. The electrodes 2f and 2g are thermally conductive members that are thermally connected to the optical element 5 through the vias 2d. For example, after the optical module 1 is assembled into a transmission device, a heat sink or a heat spreader can be mounted on the electrodes 2f and 2g that are thermally conductive members.

The optical element 5 performs, for example, the transmission and reception of an electrical signal and the transmission and reception of an optical signal L. A wavelength band of the optical signal L is, as one example, 1.2 μm or more and 1.7 μm or less. For example, the optical element 5 is an optical modulator. As one example, the optical element 5 is an IQ optical modulator. However, the optical element 5 may be an optical element other than the IQ optical modulator. For example, the optical element 5 may be a semiconductor laser or a light-receiving element. As one example, the semiconductor laser is formed of a laser diode, and the light-receiving element is formed of a photodiode. The optical element 5 is made of, for example, indium phosphide (InP). In this case, a linear expansion coefficient of the optical element 5 is approximately 4.6 [ppm/K]. As one example, a length L2 of the optical element 5 in the first direction D1 is 3 mm, and a length W2 of the optical element 5 in the second direction D2 is 3 mm. A thickness (a length in the third direction D3) of the optical element 5 is, for example, 0.1 mm.

The optical element 5 has a first surface 5b (circuit surface) facing opposite to the substrate 2, and a second surface 5c (substrate surface) facing the substrate 2. The optical element 5 is mounted on the substrate 2 such that the substrate surface (second surface) 5c faces the substrate 2. Since the first surface 5b (circuit surface) faces opposite to the substrate 2, such mounting is referred to as face-up mounting. The circuit surface is a surface on which an optical circuit component such as an optical waveguide, an optical splitter, or an optical coupler is formed. An epitaxial layer may be formed on the circuit surface, or an active element may be formed thereon. Generally, no optical circuit component is formed on the substrate surface. However, a passive element such as an electrode or a lens may be formed on the substrate surface.

The first surface 2b of the substrate 2 includes a recessed portion 2h. The optical element 5 is mounted in the recessed portion 2h. Accordingly, the amount of protrusion of the optical element 5 in the third direction D3 with respect to the first surface 2b can be suppressed. The recessed portion 2h is also referred to as a cavity. As one example, a length of the recessed portion 2h in the first direction D1 is 3.5 mm, and a length of the recessed portion 2h in the second direction D2 is 3.5 mm. A length (depth) of the recessed portion 2h in the third direction D3 is, for example, 200 μm.

A bottom surface 2j of the recessed portion 2h and the second surface 5c (substrate surface) of the optical element 5 face each other. For example, an electrode made of gold (Au) is formed on the second surface 5c of the optical element 5, and is electrically and thermally connected to the electrode 2f and the vias 2d formed on the bottom surface 2j of the recessed portion 2h. The optical element 5 is mounted, for example, by die bonding. Alloy solder such as tin-silver-copper (SnAgCu) or gold-tin (AuSn), sintered gold, silver, copper, or a conductive adhesive such as a silver paste is used for electrical and thermal connection between the electrode formed on the second surface 5c and each of the electrode 2f and the vias 2d. When electrical connection between the second surface 5cand the electrode 2f is not required, the electrode formed on the second surface 5c may be omitted, and a non-conductive adhesive such as resin may be used for thermal connection.

The vias 2d extend from the bottom surface 2j of the recessed portion 2h to the second surface 2c along the third direction D3. The recessed portion 2h is formed on the first surface 2b, for example, by cutting or etching, but may be formed by other methods. The recessed portion 2h is depressed in the third direction D3 on the first surface 2b.

For example, the optical module 1 includes a terminal 12 for external connection. The terminal 12 is a terminal for surface mounting provided on the first surface 2b of the substrate 2. The surface of the substrate 2 on which the terminal 12 for surface mounting is provided is also referred to as a mounting surface. As one example, the terminal 12 is a solder ball having a spherical shape. A diameter of the terminal 12 is, as one example, 400 μm. The terminal 12 is, for example, Sn—Ag—Cu alloy solder.

The terminal 12 is connected to an electrical wiring 2q formed on the first surface 2b of the substrate 2. The surface of the electrical wiring 2q may be protected by a passivation film. In that case, an electrode (pad) with exposed metal is formed at a portion of the electrical wiring 2q which is connected to the terminal 12. The surface of the electrode may be subjected to plating treatment using an under-bump metal. The electrical wiring 2q is electrically connected to an electrode, which is formed on the first surface 5b of the optical element 5, through a bonding wire 14. The optical module 1 includes a plurality of the terminals 12, and the plurality of terminals 12 are aligned, for example, along the first direction D1 and the second direction D2. Incidentally, the terminals 12 may be arranged in an array pattern. For example, the plurality of terminals 12 form a ball grid array (BGA). A disposition interval (pitch) of the terminals 12 is, for example, 0.8 mm.

For example, the optical module 1 is surface-mounted on an external wiring substrate 13. The terminals 12 are interposed between the substrate 2 and the wiring substrate 13. The terminals 12 electrically connect the electrical wiring 2q and an electrical wiring 13b of the wiring substrate 13 to each other. The surface of the electrical wiring 13b may be protected by a passivation film. In that case, at portions of the electrical wiring 13b on which the terminals 12 are mounted, metal is exposed from the passivation film and electrodes are formed. The surfaces of the electrodes are subjected to, for example, plating treatment using Au.

The optical module 1 includes a resin layer 7 in the recessed portion 2h of the substrate 2. The optical module 1 includes a second waveguide 8 extending from the optical element 5 to the substrate 2 in the resin layer 7, and a first waveguide 9 provided between the first surface 2b and the second surface 2c of the substrate 2. For example, a diameter of the second waveguide 8 is 5 μm, and a length of the second waveguide 8 is 200 μm. The optical module 1 includes a plurality of the second waveguides 8, and the plurality of second waveguides 8 are aligned along the second direction D2. The second waveguides 8 are made of resin.

The resin layer 7 is formed in the recessed portion 2h to cover the second waveguides 8. Namely, in a plan view of the substrate 2, the second waveguides 8 are encapsulated in the resin layer 7. In the present embodiment, the resin layer 7 is formed only around the second waveguides 8 inside the recessed portion 2h. However, the resin layer 7 may be formed such that the entire inside of the recessed portion 2h is filled therewith. For example, the resin layer 7 is made of photosensitive resin. For example, the resin layer 7 is formed through application, exposure, and development.

The recessed portion 2h functions as a flow stopper for the resin constituting the resin layer 7. However, a flow stopper may be formed using photosensitive or thermosetting resin other than the resin constituting the resin layer 7, and then the resin constituting the resin layer 7 may be applied to the flow stopper. A linear expansion coefficient of the resin layer 7 may be smaller than a linear expansion coefficient of the second waveguides 8. In this case, the influence of the thermal expansion or thermal contraction of the resin layer 7 on optical coupling between the optical element 5 and the substrate 2 through the second waveguides 8 (for example, a decrease in optical coupling efficiency) can be reduced.

As one example, the optical module 1 includes 12 second waveguides 8. A disposition interval (pitch) of the plurality of second waveguides 8 aligned along the second direction D2 is, for example, 100 μm. A distance from a center of the second waveguide 8 located at an end portion in the second direction D2 to a center of the second waveguide 8 located at an end portion opposite to the second waveguide 8 in the second direction D2 is, for example, 1.1 mm. However, the number of the second waveguides 8 may be 1 or more and 11 or less, or 13 or more. In such a manner, the number of the second waveguides 8 can be changed as appropriate. The pitch of the second waveguides 8 can also be changed as appropriate.

The second waveguides 8 are resin waveguides extending from the optical element 5 to the substrate 2. The optical element 5 transmits and receives the optical signal L to and from the outside of the optical module 1, for example, through the second waveguides 8 and the substrate 2. The second waveguides 8 function as cores through which the optical signal L passes, and the resin layer 7 functions as a cladding located around the second waveguides 8. For example, a refractive index of the resin layer 7 and a refractive index of the second waveguides 8 are 1.3 or more and 1.7 or less.

The refractive index of the resin layer 7 is smaller than the refractive index of the second waveguides 8. Accordingly, the optical signal L can be confined inside the second waveguides 8. The second waveguides 8 and the resin layer 7 may be transmissive for a wavelength band used by the optical module 1 (the wavelength band of the optical signal L). For example, the second waveguides 8 and the resin layer 7 may have a transmittance of 80% or more in the wavelength band of the optical signal L. Incidentally, when air having a refractive index of approximately 1 can be used as a cladding, the resin layer 7 can be omitted.

The second waveguides 8 are formed, for example, by three-dimensional microfabrication using a photopolymerization reaction by two-photon absorption. The second waveguides 8 are formed, for example, through the application of resin that is a raw material for the second waveguides 8, the irradiation of the resin with laser, and development. For example, the second waveguides 8 are aligned with the respective end surfaces of the optical element 5 and the first waveguides 9, and are three-dimensionally formed afterwards. In this case, low-loss optical coupling through the second waveguides 8 is possible. Furthermore, high-accuracy alignment when the optical element 5 is mounted on the substrate 2 is not required.

One end of the second waveguide 8 is optically coupled to an optical waveguide formed in the optical element 5 at the end surface of the optical element 5. This optical coupling is also referred to as edge coupling. In edge coupling, a first end surface and a second end surface opposite to the first end surface of the optical waveguide are disposed to face each other and to be close to each other. Light output from the first end surface is input to the second end surface. Accordingly, in edge coupling, smaller optical coupling is possible compared to evanescent coupling to be described later. In a plan view of the substrate 2, an optical coupling surface between the second waveguide 8 and the optical waveguide of the optical element 5 may be inclined with respect to an optical axis of the second waveguide 8 and an optical axis of the optical waveguide. An inclination angle of the inclination is, for example, 4° or more, and may be 8° or more. An anti-reflection (AR) film may be formed on the end surface of the optical waveguide of the optical element 5. Reflected return light of the optical signal L at an optical coupling portion between the second waveguide 8 and the optical waveguide of the optical element 5 can be reduced by one of the above-described inclination and the anti-reflection film.

An end portion of the second waveguide 8 opposite to the optical element 5 is optically coupled to the first waveguide 9 by edge coupling. Namely, the optical waveguide of the optical element 5 is optically coupled to the first waveguide 9 through the second waveguide 8. The size and shape of a cross section of the second waveguide 8 when taken along a plane orthogonal to an extending direction of the second waveguide 8 may change on the way from the optical element 5 to the substrate 2. In addition, the second waveguide 8 may extend linearly from the optical element 5 to the substrate 2, or may include a curved portion. For example, the second waveguide 8 is made of resin and has elasticity. For this reason, the second waveguide 8 can withstand deformation caused by, for example, thermal expansion or thermal contraction of the second waveguide 8 or warpage of the substrate 2. When the second waveguide 8 includes the curved portion, the generation of stress due to thermal expansion or thermal contraction can be suppressed, and the stability of optical coupling in the second waveguide 8 can be improved.

The substrate 2 includes the first waveguide 9 extending from an inner surface 2k of the recessed portion 2h to an outer surface 2m of the substrate 2. The first waveguide 9 is a glass waveguide. The outer surface 2m extends in both the second direction D2 and the third direction D3. For example, a cross section of the first waveguide 9 when the first waveguide 9 is taken along a plane orthogonal to an extending direction of the first waveguide 9 has a rectangular shape. A width of the first waveguide 9 is, for example, 10 μm. A length of the first waveguide 9 is, for example, 2 mm. The first waveguide 9 has a higher refractive index than the glass portion of the substrate 2 located around the first waveguide 9. Accordingly, the glass portion of the substrate 2 functions as a cladding, and the first waveguide 9 functions as a core. The optical signal L can be confined inside the first waveguide 9 functioning as a core. For example, the refractive index of the first waveguide 9 and the refractive index of the glass portion of the substrate 2 are 1.4 or more and 1.5 or less.

The first waveguide 9 and the glass portion of the substrate 2 are transmissive for the wavelength band of the optical signal L used by the optical module 1. For example, the first waveguide 9 has approximately the same refractive index as a core of an optical fiber F1 to be described later, and the glass portion of the substrate 2 has approximately the same refractive index as the cladding of the optical fiber F1. A difference in relative refractive index between the first waveguide 9 functioning as a core and the glass portion of the substrate 2 functioning as a cladding is, for example, 0.2% or more and 0.5% or less (0.35% as one example).

The optical module 1 includes a plurality of the first waveguides 9, and the plurality of first waveguides 9 are aligned along the second direction D2. For example, the first waveguide 9 includes a first portion 9b optically connected to the second waveguide 8 and extending along the first direction D1; a third portion 9d optically connected to the optical fiber F1 held by an optical fiber array 11 to be described later and extending along the first direction D1; and a second portion 9c that smoothly connects the first portion 9b and the third portion 9d. An interval (pitch) between two second portions 9c aligned along the second direction D2 increases as the second portions 9c extend away from the first portions 9b. An interval between two first waveguides 9 aligned along the second direction D2 in the first portions 9b is, for example, 100 μm. An interval between two first waveguides 9 aligned along the second direction D2 in the third portions 9d is, for example, 250 μm. As one example, the optical module 1 includes 12 first waveguides 9. However, the number of the first waveguides 9 is not limited to 12, and can be changed as appropriate. The pitch of the first waveguides 9 can also be changed as appropriate.

For example, the optical module 1 includes the optical fiber array 11 that holds a plurality of the optical fibers F1. For example, the optical fiber array 11 may include a V-groove substrate in which a plurality of V-grooves on which each optical fiber F1 is placed are formed, and a lid that covers the V-groove substrate. The optical fibers F1 are adhesively fixed between the V-groove substrate and the lid. End surfaces of the optical fibers F1 in the optical fiber array 11 are optically polished. In addition, the optical fiber array 11 may be a ferrule having a plurality of optical fiber holding holes through which each optical fiber F1 passes.

As one example, the optical fiber F1 is a single-core single-mode fiber. The optical fiber F1 may be, for example, a polarization maintaining fiber. However, the optical fiber F1 may be a multicore fiber or may be a multimode fiber. In the optical fiber array 11, the plurality of optical fibers F1 are aligned along the second direction D2. An interval (pitch) of two optical fibers F1 aligned along the second direction D2 is, for example, 250 μm. A distance from a center of the optical fiber F1 located at an end portion in the second direction D2 to a center of the optical fiber F1 located at an end portion opposite to the optical fiber F1 in the second direction D2 is, for example, 2.75 mm. For example, a diameter of the optical fiber F1 is 125 μm, and a core diameter of the optical fiber F1 is 10 μm. For example, the number of the optical fibers F1 is 12. However, the number of the optical fibers F1 can be changed as appropriate. The size and disposition mode of the optical fibers F1 are not limited to the above example, and can be changed as appropriate.

Since stress due to bending, pulling, or the like of the optical fibers F1 may be concentrated at positions in the substrate 2 close to the optical fiber array 11 (for example, regions in the substrate 2 in which the first waveguides 9 are formed), for example, cracks occur in the substrate 2 due to distortion and the optical loss increases, which is a concern. However, in the present embodiment, since the first waveguides 9 are formed inside the substrate 2, in a plan view of the substrate 2, the terminals 12 can be formed at the peripheries of the first waveguides 9 and at portions overlapping the first waveguides 9. Since formation regions of the first waveguides 9 can be fixed to the wiring substrate 13 by the terminals 12 formed on the substrate 2 at the periphery of the optical fiber array 11, distortion due to the stress can be suppressed, and the reliability of the optical module 1 can be improved.

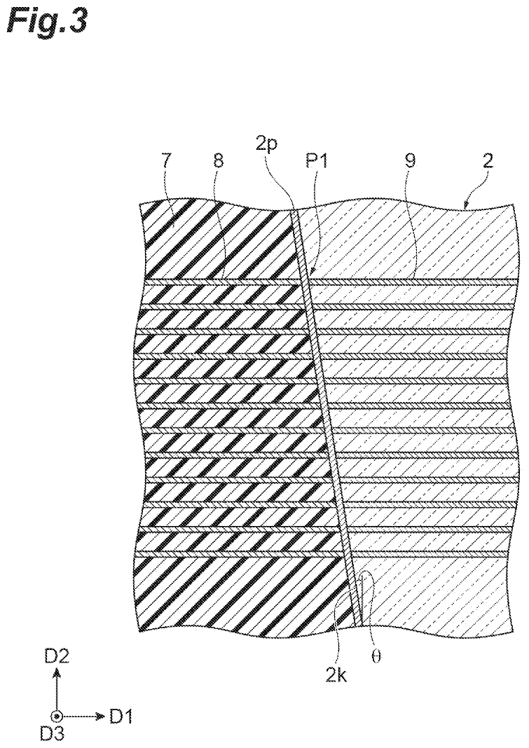

On the outer surface 2m of the substrate 2, the first waveguides 9 are optically coupled to the optical fibers F1 held by the optical fiber array 11. The first waveguides 9 are optically coupled to the second waveguides 8 on the inner surface 2k of the recessed portion 2h. FIG. 3 is a view showing an optical coupling portion P1 as a modification example at which the first waveguides 9 are connected to the second waveguides 8, and is an enlarged plan view showing the optical coupling portion P1. As shown in FIG. 3, end surfaces of the second waveguides 8 are edge-coupled to the end surfaces of the first waveguides 9 facing the end surfaces along the first direction D1. In a plan view, the inner surface 2k of the recessed portion 2h of the substrate 2 is inclined with respect to the optical axes of the second waveguides 8 and optical axes of the first waveguides 9. For example, an inclination angle θ of the inner surface 2k with respect to the second direction D2 is 4° or more, and may be 8° or more. Accordingly, reflection loss can be reduced without increasing coupling loss at the optical coupling portion P1 between the second waveguides 8 and the first waveguides 9.

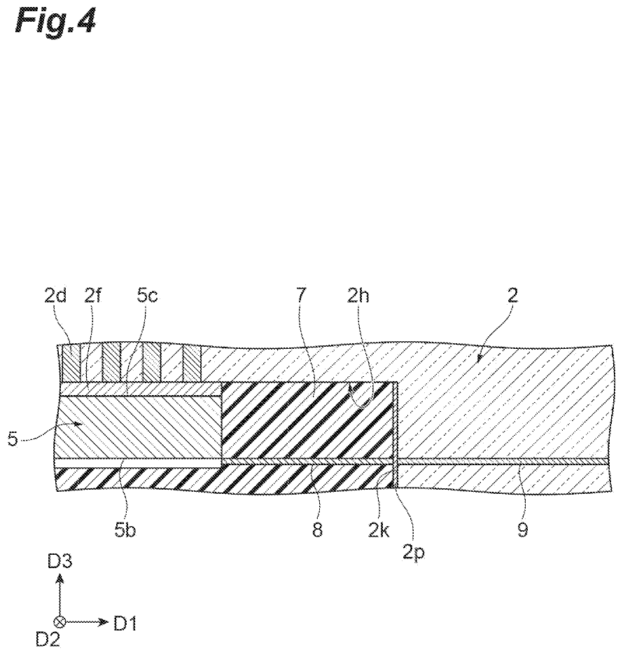

FIG. 4 is a cross-sectional view of the substrate 2, the optical element 5, the resin layer 7, the second waveguide 8, and the first waveguide 9 when taken along a plane extending along both the first direction D1 and the third direction D3. As shown in FIG. 4, an anti-reflection film 2p is formed on the inner surface 2k of the recessed portion 2h. However, when the reflection loss is small or the like, the anti-reflection film 2p can also be omitted.

The first waveguide 9 is formed, for example, by inducing a change in refractive index inside the substrate 2 through multiphoton absorption of femtosecond laser. For example, the first waveguide 9 may be formed by an ion exchange method in which silver (Ag) or potassium (K) is introduced into glass by heat or an electric field. The shape and size of a cross section of the first waveguide 9 when taken along a plane orthogonal to the extending direction of the first waveguide 9 may change on the way from the inner surface 2k of the recessed portion 2h to the outer surface 2m of the substrate 2. In addition, the first waveguide 9 may extend linearly from the inner surface 2k of the recessed portion 2h to the outer surface 2m of the substrate 2, or may include a curved portion.

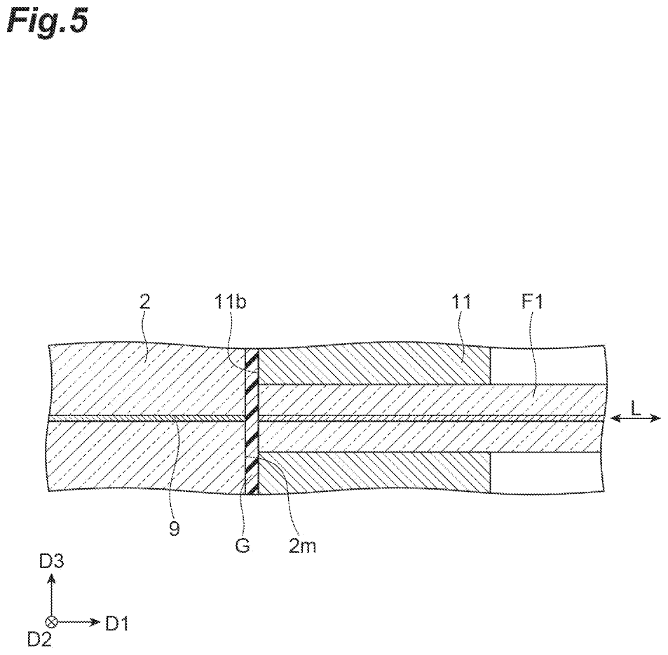

FIG. 5 is a view schematically showing the first waveguide 9 and the optical fiber F1 held by the optical fiber array 11. As shown in FIG. 5, the first waveguide 9 and the optical fiber array 11 are optically coupled to each other through an adhesive G. For example, the adhesive G is photosensitive and thermosetting. A thickness of the adhesive G (a distance from the outer surface 2m of the substrate 2 to an end surface 11b of the optical fiber array 11) is, for example, 10 μm. For example, the adhesive G is transmissive for the wavelength band of the optical signal L used by the optical module 1. For example, the adhesive G has approximately the same refractive index as the first waveguide 9 and the core of the optical fiber F1. In this case, even when there is a slight scratch on the outer surface 2m of the substrate 2, the end surface of the optical fiber F1, or the like, the reflection and scattering of the optical signal L can be suppressed, and low-loss optical coupling becomes possible. Incidentally, an anti-reflection film may be formed on the outer surface 2m of the substrate 2.

Alignment between the first waveguide 9 and the optical fiber array 11 is performed, for example, by active alignment. For example, the position of the optical fiber array 11 where the optical coupling loss between the optical fiber array 11 and the first waveguide 9 is minimized is found by moving the optical fiber array 11 in a state where the adhesive G is not cured. Then, the adhesive G is cured by irradiating the adhesive G with ultraviolet rays, to finalize the position of the optical fiber array 11 with respect to the first waveguide 9. However, alignment between the first waveguide 9 and the optical fiber array 11 is performed, for example, by passive alignment. In this case, guide holes aligned with the first waveguide 9 and the optical fiber F1 on the outer surface 2m of the substrate 2 and the end surface 11b of the optical fiber array 11 are provided, and alignment is performed by inserting guide pins into the guide holes. Furthermore, a structure that reinforces the fixation of the substrate 2 and the optical fiber array 11 may be provided. The structure is, for example, a reinforcing plate that spans between the substrate 2 and the optical fiber array 11.

For example, the optical fiber F1 extends from the optical fiber array 11 along the first direction D1. For example, an optical connector is connected to an end portion of the optical fiber F1 opposite to the substrate 2. The optical module 1 may be connectable to an optical cable outside the optical module 1 through the optical connector. Namely, the optical module 1 may be a pigtail module including an optical connector at the tip of the optical fiber F1 drawn out from the optical module 1. In addition, for example, an optical receptacle may be mounted on the substrate 2, and a structure for attaching and detaching an external optical cable may be provided on the substrate 2.

As described above, in the optical module 1, the optical element 5 and the outside of the optical module 1 (for example, the optical fibers F1) are optically coupled to each other through the second waveguides 8 and the first waveguides 9, and the transmission and reception of the optical signal L by the optical module 1 becomes possible. Since the optical module 1 is surface-mounted on the wiring substrate 13, and realizes the suppression of stress and efficient temperature control, the optical element is mounted on the first surface 2b (recessed portion 2h) facing the wiring substrate 13. As a result, there is no sufficient space, in which an optical system (for example, a mirror) that extracts the optical signal L from the optical element 5 is disposed, between the wiring substrate 13 and the first surface 2b. However, the optical module 1 can extract the optical signal L from the outer surface 2m of the substrate 2 with low loss by including the second waveguides 8 and the first waveguides 9.

Next, actions and effects obtained from the optical module 1 according to the present embodiment will be described. The optical module 1 includes the substrate 2 made of glass and having the first surface 2b, the second surface 2c, and the vias 2d; the optical element 5; and the electrode 2g. The optical element 5 is mounted on the first surface 2b of the substrate 2, and the electrode 2g is provided on the second surface 2c opposite to the first surface 2b. The electrode 2g provided on the second surface 2c is thermally connected to the optical element 5 through the vias 2d. Therefore, since heat generated from the optical element 5 is released from the substrate 2 through the vias 2d and the electrode 2g, the heat can be dissipated from the optical element 5. The first waveguides 9 are provided between the first surface 2b and the second surface 2c of the substrate 2, and the second waveguides 8 are provided on the first surface 2b of the substrate 2. The optical signal L is input to and output from the outside of the optical module 1 through the second waveguides 8 and the first waveguides 9. Therefore, since the optical element 5 is optically coupled to the outside of the optical module 1 through the second waveguides 8 and the first waveguides 9, the input and output of the optical signal L can be appropriately performed.

As described above, the first surface 2b of the substrate 2 may include the recessed portion 2h. The optical element 5 may be mounted in the recessed portion 2h, and the second waveguides 8 may be provided in the recessed portion 2h. In this case, the thickness of the optical module 1 can be suppressed by mounting the optical element 5 in the recessed portion 2h and providing the second waveguides 8 in the recessed portion 2h.

As described above, the substrate 2 may extend in the first direction D1 and the second direction D2 intersecting the first direction D1, and may have a thickness in the third direction D3 intersecting both the first direction D1 and the second direction D2. The second waveguides 8 may be optically coupled to the first waveguides 9 through the inner surface 2k of the recessed portion 2h, and the inner surface 2kmay be inclined with respect to the second direction D2. In this case, the reflection of the optical signal L on the inner surface 2k can be suppressed.

As described above, the second waveguides 8 may be optically coupled to the first waveguides 9 through the inner surface 2k of the recessed portion 2h, and the anti-reflection film 2p may be provided on the inner surface 2k. In this case, the reflection of the optical signal L on the inner surface 2k can be suppressed.

The optical module 1 is optically coupled to the external optical fibers F1 through the second waveguides 8 and the first waveguides 9. The one ends of the second waveguides 8 are optically coupled to the optical element 5, and the end portions of the second waveguides 8 opposite to the optical element 5 are optically coupled to the first waveguides 9. Since the second waveguides 8 are aligned with the optical element 5 and the first waveguides 9, and are three-dimensionally formed, low-loss optical coupling is possible. Furthermore, since the second waveguides 8 are made of a resin material and have elasticity, the second waveguides 8 have high resistance to deformation caused by thermal expansion, thermal contraction, and warpage of the second waveguides 8 and components around the second waveguides 8. Therefore, the stable operation of the optical module 1 can be realized.

One ends of the first waveguides 9 are optically coupled to the second waveguides 8, and end portions of the first waveguides 9 opposite to the second waveguides 8 are optically coupled to the optical fiber array 11. Since the first waveguides 9 are three-dimensionally formed inside the substrate 2, low-loss optical coupling is possible according to the pitches of the second waveguides 8 and the optical fibers F1 held by the optical fiber array 11. Furthermore, since the first waveguides 9 have high resistance to deformation caused by thermal expansion, thermal contraction, and warpage, the stable operation of the optical module 1 can be realized.

Next, various modification examples of the optical module according to the present disclosure will be described. A part of the configuration of optical modules according to various modification examples to be described later is the same as a part of the configuration of the optical module 1 described above. Therefore, hereinafter, descriptions that overlap with the description of the optical module 1 are denoted by the same reference signs, and will be omitted as appropriate.

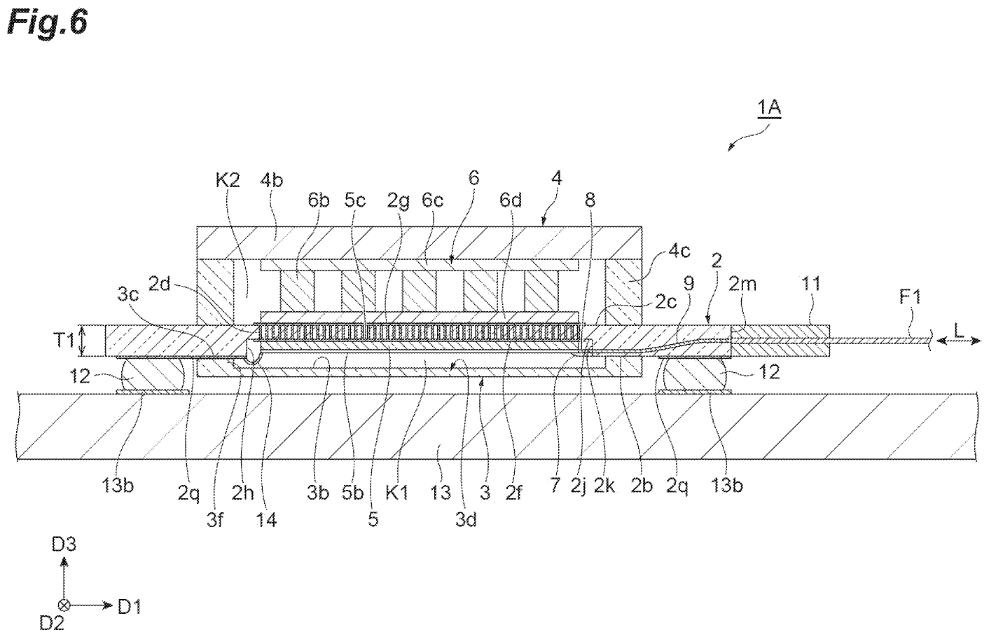

FIG. 6 is a cross-sectional view of an optical module 1A according to a first modification example. The optical module 1A includes a first sealing member 3, a second sealing member 4, and a temperature control element 6. The first sealing member 3 includes, for example, a recessed portion 3b. The optical element 5 mounted on the first surface 2b of the substrate 2 is accommodated at a position facing the recessed portion 3b. The first sealing member 3 is made of, for example, glass. In this case, since the material of the first sealing member 3 is the same as the material of the glass portion of the substrate 2, stress on the optical element 5 due to thermal expansion or thermal contraction can be reduced. However, the first sealing member 3 may be made of a material other than glass. However, the material of the first sealing member 3 may be a material having airtightness and thermal insulation.

The recessed portion 3b of the first sealing member 3 is depressed in the third direction D3. The first sealing member 3 may be such that a counterbore is formed in a glass plate as the recessed portion 3b. The recessed portion 3b is also referred to as a cavity. By connecting connection surface 3c, which surrounds the recessed portion 3b in a plan view of the substrate 2 (when viewed along the third direction D3), to the first surface 2b of the substrate 2, a first airtight space K1 defined by the recessed portion 3b of the first sealing member 3 and the first surface 2b of the substrate 2 is formed.

The optical element 5 mounted on the first surface 2b and the second waveguides 8 are accommodated in the first airtight space K1. Accordingly, for example, deterioration of the optical element 5 and the second waveguides 8 due to moisture can be suppressed, and the optical module 1A can be made highly reliable. For example, the entirety of the optical element 5 is accommodated in the recessed portion 2h. In this case, the recessed portion 3b of the first sealing member 3 can be omitted. The difference between a linear expansion coefficient of the first sealing member 3 and the linear expansion coefficient of the substrate 2 may be small. By setting the difference in linear expansion coefficient to be small, stress generated due to a change in the temperature of the optical module 1A can be reduced. A length of the first sealing member 3 in the first direction D1 is less than or equal to the length of the substrate 2 in the first direction D1. A length of the first sealing member 3 in the second direction D2 is less than or equal to the length of the substrate 2 in the second direction D2.

In the optical module 1A, the first sealing member 3 is a first lid. However, the first sealing member 3 may be other than a lid. For example, instead of using the first sealing member 3, a protection film may be formed to cover the optical element 5 and the second waveguides 8. The protection film can also protect the optical element 5 and the second waveguides 8 from moisture, a trace amount of gas generated from other components, or the like. The protection film is made of, for example, an inorganic material such as SiO₂ or SiN. Incidentally, in order to alleviate stress caused by the protection film, the protection film may be formed after a sacrificial layer is formed on the optical element 5 and the second waveguides 8, and then the sacrificial layer may be removed. For example, in order to remove the sacrificial layer, forming an opening on the protection film is required, but the opening can be closed by further forming a protection film after removing the sacrificial layer.

For example, the first sealing member 3 includes a bottom portion 3d extending in both the first direction D1 and the second direction D2, and a side wall portion 3f extending from the bottom portion 3d in the third direction D3. As one example, the length of the first sealing member 3 in the first direction D1 is 4 mm, and the length of the first sealing member 3 in the second direction D2 is 4 mm. A height (a length in the third direction D3) of the first sealing member 3 is, for example, 0.3 mm. For example, the bottom portion 3d and the side wall portion 3f are integrated. However, the bottom portion 3d and the side wall portion 3f may be separate bodies, and the first sealing member 3 may be configured by joining the side wall portion 3f having a frame shape and having a cavity to the bottom portion 3d that is a flat plate. In a plan view of the substrate 2, the side wall portion 3f has a shape surrounding the periphery of the recessed portion 3b.

The first sealing member 3 is joined (sealed) to the substrate 2, for example, through an adhesive (also referred to as a sealant). The adhesive is made of, for example, metal. As a specific example, the adhesive is made of gold-tin (AuSn). In this case, the first sealing member 3 is joined to the substrate 2 by heating and melting gold-tin applied to the connection surface 3c. At this time, the connection surface 3c of the first sealing member 3 and a connection portion of the substrate 2 connected to the connection surface 3c are metalized, for example, with metal. For example, the connection surface 3c and the glass surface of the connection portion of the substrate 2 are metalized with gold (Au). The first airtight space K1 with high airtightness is formed by metal joining. For example, a leakage amount of the first airtight space K1 according to a fine leakage test is less than 1.0×10⁻⁹ [Pa·m³/s]. Accordingly, the reliability of the optical element 5 can be further enhanced. The heating and melting is performed, for example, by laser irradiation or heater heating.

The adhesive used to join the first sealing member 3 and the substrate 2 may be made of, for example, solder, glass frit, or epoxy resin. In addition, for example, a surface oxide film (SiO₂) of the first sealing member 3 and a surface oxide film of the substrate 2 may be directly joined without using an adhesive. In addition, the surfaces on which oxide films and metal are formed may be directly joined to each other (also referred to as hybrid bonding). When an insulator is used as the adhesive and when joining is performed by hybrid bonding, the first airtight space K1 can be airtightly sealed, and an electrical wiring (feedthrough) that connects the first airtight space K1 and the outside of the first sealing member 3 can be formed. The first sealing member 3 has been described above. However, when deterioration of the optical element 5 and deterioration of the second waveguides 8 due to moisture, a trace amount of gas generated from other components, or the like are not a problem, the first sealing member 3 can also be omitted.

The second sealing member 4 is connected to the second surface 2c of the substrate 2. The second sealing member 4 accommodates the temperature control element 6 mounted on the second surface 2c of the substrate 2. The second sealing member 4 is connected to the second surface 2c, and airtightly seals the temperature control element 6. The second sealing member 4 includes, for example, a heat dissipation member 4b extending in both the first direction D1 and the second direction D2, and a side wall portion 4c extending from the heat dissipation member 4b in the third direction D3.

The heat dissipation member 4b has a thermal conductivity higher than the thermal conductivity of the substrate 2. The heat dissipation member 4b has a plate shape. The heat dissipation member 4b is made of, for example, silicon (Si). The side wall portion 4c is made of, for example, glass. However, the material of the heat dissipation member 4b and the material of the side wall portion 4c are not limited to the above examples. For example, the heat dissipation member 4b may be made of metal. In addition, the side wall portion 4c may be made of ceramic.

The heat dissipation member 4b functions as a heat transfer path located between the temperature control element 6 and the outside of the optical module 1A. For example, the heat dissipation member 4b is joined to the side wall portion 4c through an adhesive. For example, in the second sealing member 4, the heat dissipation member 4b made of silicon (Si) and the side wall portion 4c made of glass are integrated through an adhesive. The difference between a linear expansion coefficient of the heat dissipation member 4b and the linear expansion coefficient of the substrate 2 may be small. By setting the difference in linear expansion coefficient to be small, stress generated due to a change in the temperature of the optical module 1A can be reduced.

For example, a length of the second sealing member 4 in the first direction D1 is less than or equal to the length of the substrate 2 in the first direction D1. A length of the second sealing member 4 in the second direction D2 is less than or equal to the length of the substrate 2 in the second direction D2. As one example, the length of the second sealing member 4 in the first direction D1 is the same as the length of the first sealing member 3 in the first direction D1, and the length of the second sealing member 4 in the second direction D2 is the same as the length of the first sealing member 3 in the second direction D2. In this case, the length of the second sealing member 4 in the first direction D1 is 4 mm, and the length of the second sealing member 4 in the second direction D2 is 4 mm. For example, a height (a length in the third direction D3) of the second sealing member 4 is larger than the height of the first sealing member 3. As one example, the height of the second sealing member 4 is 1.5 mm.

A second airtight space K2 is formed between the substrate 2 and the second sealing member 4. The second surface 2c of the substrate 2 and the side wall portion 4c and the heat dissipation member 4b of the second sealing member 4 define the second airtight space K2. For example, a volume of the first airtight space KI of the first sealing member 3 is smaller than a volume of the second airtight space K2 of the second sealing member 4. For example, the first airtight space K1 is more airtight than the second airtight space K2. For example, the leakage amount from the first sealing member 3 is smaller than the leakage amount from the second sealing member 4.

In the optical module 1A, the volume of the space inside the first sealing member 3 in which the optical element 5 is accommodated is smaller than the volume of the space inside the second sealing member 4. Therefore, since the volume of the first airtight space K1 that is an airtightly sealed portion for the optical element 5 is smaller than the volume of the second airtight space K2 of the second sealing member 4, the optical element 5 is more reliably protected from the influence of stress caused by a change in temperature. Furthermore, the optical module 1A does not include the temperature control element 6 in the first airtight space K1. Namely, in the first airtight space K1 of the optical module 1A, the optical element 5 is airtightly sealed separately from the temperature control element 6. Therefore, since the outflow of gas from the temperature control element 6 does not occur in the first airtight space K1, the reliability of the optical element 5 is further improved. Incidentally, in the optical module 1A, only the optical element 5 is accommodated in the first airtight space K1. However, for example, a circuit chip such as an IC that drives the optical element 5 may be accommodated in the first airtight space K1.

The second sealing member 4 is joined to the substrate 2, for example, through an adhesive. As one example, the first sealing member 3 is joined to the substrate 2 through gold-tin (AuSn), and the second sealing member 4 is joined to the substrate 2 through a resin adhesive. For example, the second sealing member 4 is joined to the substrate 2, for example, through ultraviolet curable resin. In this case, the second airtight space K2 may be less airtight than the first airtight space K1. However, an airtightness of the second airtight space K2 may be lower than an airtightness of the first airtight space K1. As one example, a leakage amount of the second airtight space K2 according to a fine leakage test may be less than 1.0×10⁻⁹ [Pa·m³/s]. In this case, the occurrence of dew condensation on the temperature control element 6 accommodated in the second airtight space K2 can be suppressed, and the reliability of the temperature control element 6 can be improved.

Solder, glass frit, or epoxy resin may be used as an adhesive to join the second sealing member 4 and the substrate 2. In addition, for example, without using an adhesive, a surface oxide film (SiO₂) on a joint surface of the side wall portion 4c and a surface oxide film on the second surface 2c of the substrate 2 may be directly joined, or the surfaces on which oxide films and metal are formed may be joined to each other by hybrid bonding. When an insulator is used as the adhesive and when joining is performed by hybrid bonding, the second airtight space K2 can be airtightly sealed, and an electrical wiring that connects the second airtight space K2 and the outside of the second sealing member 4 can be formed. Incidentally, a moisture-absorbing material that adsorbs moisture or a decomposing agent that decomposes moisture may be disposed in the second airtight space K2. In the second airtight space K2, the surfaces of the substrate 2, the second sealing member 4, and the temperature control element 6 may be protected (coated) with an insulating film such as resin such that moisture is prevented from infiltrating into the insides thereof even in the case of occurrence of dew condensation when the second airtight space K2 has low airtightness.

In the optical module 1A, the second sealing member 4 is a second lid. However, the second sealing member 4 may be other than a lid. For example, the second sealing member 4 may be a protection film formed on the temperature control element 6. The protection film is similar to the protection film forming the first sealing member 3 described above. Incidentally, when there is no concern about dew condensation on the temperature control element 6 in an environment in which the optical module 1A is used, the airtightness of the second sealing member 4 is not required. Furthermore, the second sealing member 4 can also be omitted.

The temperature control element 6 is sandwiched, for example, between the heat dissipation member 4b and the substrate 2. The temperature control element 6 is thermally connected to the heat dissipation member 4b. The temperature control element 6 is, for example, a thermoelectric cooler. For example, the temperature control element 6 includes a plurality of Peltier elements 6b, and a first substrate 6c and a second substrate 6d that sandwich the plurality of Peltier elements 6btherebetween in the third direction D3. The first substrate 6c and the second substrate 6d are, for example, ceramic substrates made of aluminum nitride (AlN) or the like. The first substrate 6c comes into contact with the heat dissipation member 4b. The second substrate 6d is connected to the vias 2d through the electrode 2g formed on the second surface 2c of the substrate 2. As one example, a length of the temperature control element 6 in the first direction D1 is 3 mm, and a length of the temperature control element 6 in the second direction D2 is 3 mm. For example, a thickness (a length in the third direction D3) of the temperature control element 6 is, for example, 1 mm.

For example, the temperature control element 6 keeps the temperature of the optical element 5 constant through the substrate 2 under control of a Peltier controller outside the optical module 1A. The temperature control element 6 absorbs or dissipates heat through the heat dissipation member 4b. For thermal connection, a thermal interface material (TIM) may be interposed between the first substrate 6c and the heat dissipation member 4b and between the second substrate 6d and the electrode 2g. The thermal interface material is made of, for example, metal paste, solder, or resin. The resin may contain a filler having good thermal conductivity.

Incidentally, by forming an electrode other than the electrode 2g on the second surface 2c of the substrate 2, and by electrically connecting an electrical terminal of the temperature control element 6 to the electrode, for example, through wire bonding, electric power can be supplied to the temperature control element 6. In addition, for example, a thermistor may be disposed on the second surface 2c or the first surface 2b of the substrate 2, and the thermistor may be used as a monitor for temperature measurement. The substrate surface (second surface 5c) of the optical element 5 is fixed to the substrate 2, and is connected to the temperature control element 6 through the substrate 2. On the other hand, the circuit surface (first surface 5b) of the optical element 5 is not in contact with other components (solids). Therefore, compared to a configuration in which both the circuit surface and the substrate surface are fixed, the influence of stress on the optical element 5 caused by a change in temperature can be suppressed.

More specifically, if the optical element 5 is sandwiched between the temperature control element 6 and the substrate 2 in the second airtight space K2 (when the optical element 5 is mounted on the substrate 2 such that the circuit surface faces the second surface 2c of the substrate 2, and the temperature control element 6 is mounted on the substrate surface of the optical element 5), since the second sealing member 4, the temperature control element 6, the optical element 5, and the substrate 2 expand or contract according to the respective linear expansion coefficients as the temperature changes, there is a possibility that a large stress is applied to the optical element 5. However, in the optical module 1A, since only the substrate surface of the optical element 5 is fixed, the thermal stress applied to the optical element 5 can be reduced. Accordingly, the reliability of the optical element 5 is improved. In addition, a change in the optical characteristics (for example, wavelength characteristics) of the optical element 5 due to stress is suppressed, and the stable operation of the optical module 1A is possible.

The optical element 5 is thermally connected to the temperature control element 6 through the electrode 2f and the vias 2d of the substrate 2. On the other hand, components other than the electrode 2f and the vias 2d around the optical element 5 are made of a material with low thermal conductivity such as air, resin, or glass. As described above, the optical element 5 is connected to the electrical wiring 2q through the bonding wire 14. For example, the electrical wiring 2q has high thermal resistance due to being as thin as approximately 5 μm. For this reason, the optical element 5 is thermally floated (thermally insulated) except for the vias 2d, and is efficiently controlled in temperature by the temperature control element 6. For example, a thermal resistance between the optical element 5 and the temperature control element 6 is one or more orders of magnitude lower than a thermal resistance between the optical element 5 and the outside of the optical module 1A.

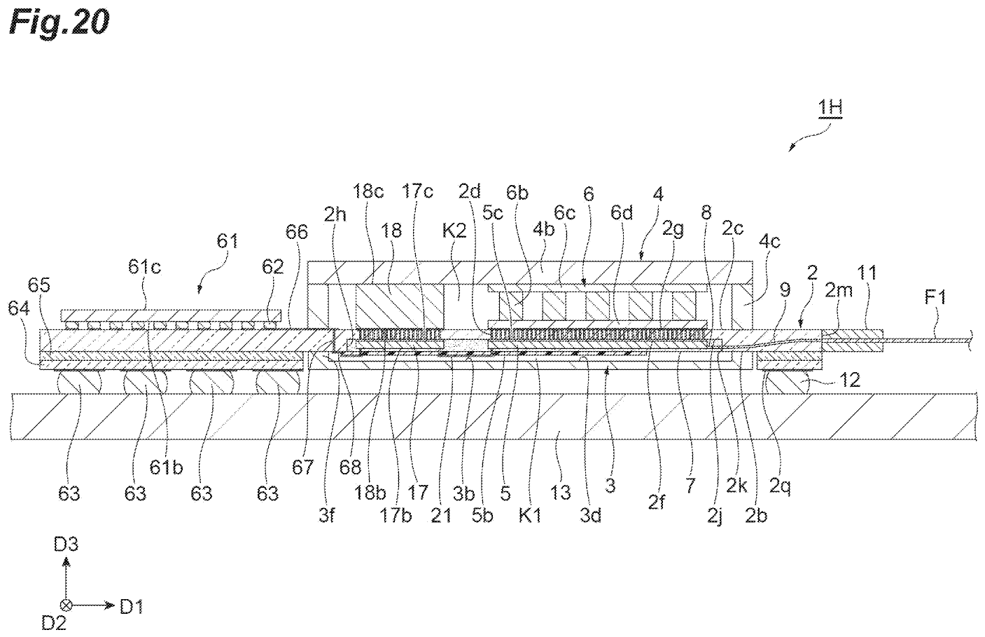

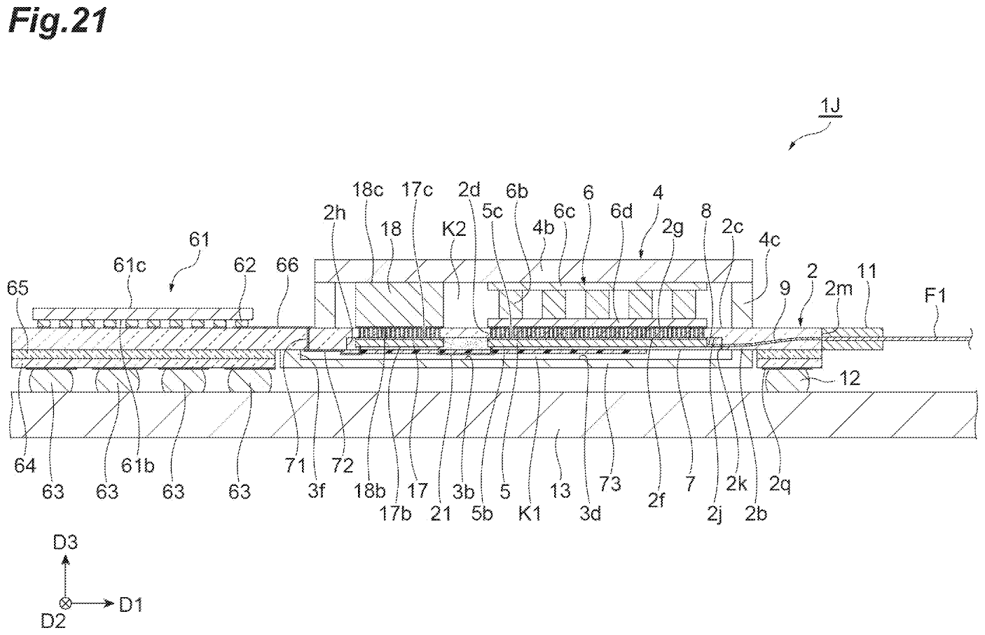

For example, the inside and the outside of the first airtight space K1 may be electrically connected through the second airtight space K2 using electrical wirings 66 and 67 in FIG. 20 to be described later, or may be directly and electrically connected using an electrical wiring 71 in FIG. 21 to be described later. However, in either case, in order to electrically connect the first airtight space K1 and the second surface 2c of the substrate 2, electrical wirings (vias) that electrically connect the second surface 2c and the terminals 12 on the first surface 2b are further required. Furthermore, in the optical module 1A, the first sealing member 3 airtightly seals the optical element 5 and the second waveguides 8. Therefore, deterioration of the optical element 5 and the second waveguides 8 due to moisture can be suppressed, and the optical module 1A can be made even more reliable.

As described above, the optical module 1A according to the first modification example includes the substrate 2 made of glass and having the first surface 2b, the second surface 2c, and the vias 2d; the optical element 5; and the temperature control element 6. The optical element 5 is mounted on the first surface 2b of the substrate 2. The optical module 1 A includes the first sealing member 3 that is connected to the first surface 2b, and that airtightly seals the optical element 5. Therefore, since the optical element 5 mounted on the first surface 2b of the substrate 2 is airtightly sealed by the first sealing member 3, the optical element 5 can be protected. The substrate 2 includes the vias 2d penetrating between the first surface 2b and the second surface 2c. The optical element 5 and the temperature control element 6 can be thermally connected to each other through the vias 2d.

The optical module 1A is surface-mounted such that the first surface 2b of the substrate 2 faces the wiring substrate 13 outside the optical module 1A. The optical element 5 is mounted in the recessed portion 2h, which is formed on the first surface 2b of the substrate 2, such that the second surface 5c (substrate surface) faces the substrate 2. The temperature control element 6 is mounted on the second surface 2c opposite to the first surface 2b. The substrate 2 includes the vias 2d penetrating between the bottom surface 2j and the second surface 2c. Therefore, the optical element 5 and the temperature control element 6 can be thermally connected to each other through the vias 2d.

Since the substrate 2 has good thermal insulation due to being made of glass, and the first surface 5b (circuit surface) of the optical element 5 is insulated from the outside of the optical module 1A, the temperature of the optical element 5 can be kept constant regardless of temperature outside the optical module 1A. In addition, in the optical element 5, since only the second surface 5c is fixed to the substrate 2, the optical element 5 can be protected from stress caused by a change in temperature. Stable light output in the optical module 1A can be obtained by stable temperature control and protection from stress.

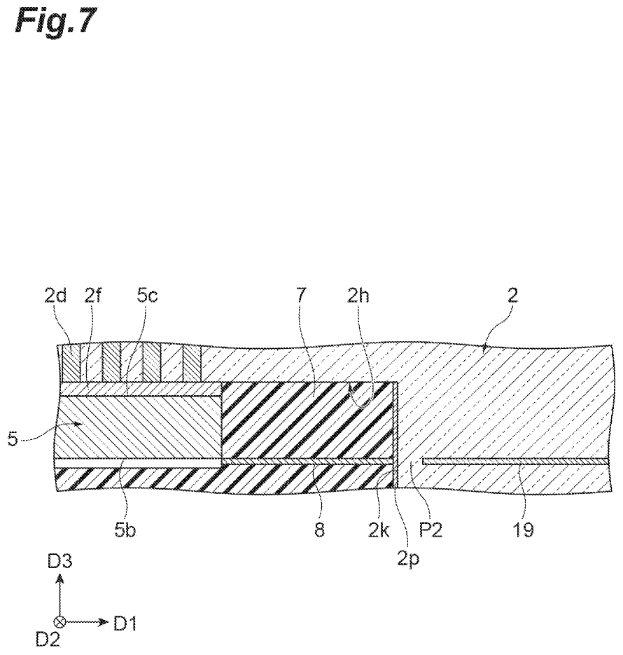

FIG. 7 is a view showing the second waveguide 8 and a first waveguide 19 of the optical module according to a second modification example. FIG. 7 shows a cross section of the substrate 2, the optical element 5, the second waveguide 8, and the first waveguide 19 when taken along a plane extending in both the first direction D1 and the third direction D3. At an optical coupling portion P2 between the second waveguide 8 and the first waveguide 19, the glass material of the substrate 2 is interposed between an end portion of the first waveguide 19 and the inner surface 2k of the recessed portion 2h. Namely, an end surface of the first waveguide 19 is spaced apart from the inner surface 2k.

The first waveguide 19 is not exposed on the inner surface 2k of the recessed portion 2h. Accordingly, the first waveguide 19 can be protected from the outside of the substrate 2. For example, damage to and contamination of the first waveguide 19 during processing of the substrate 2 or during assembly of the optical module 1 can be suppressed. As a result, an increase in optical loss in the first waveguide 19 can be suppressed. A thickness (a length in the first direction D1) of the glass portion of the substrate 2 interposed between the end portion of the first waveguide 19 and the inner surface 2k of the recessed portion 2h is, for example, 20 μm or less, and may be 10 μm or less. In this case, low-loss optical coupling between the second waveguide 8 and the first waveguide 19 can be realized.

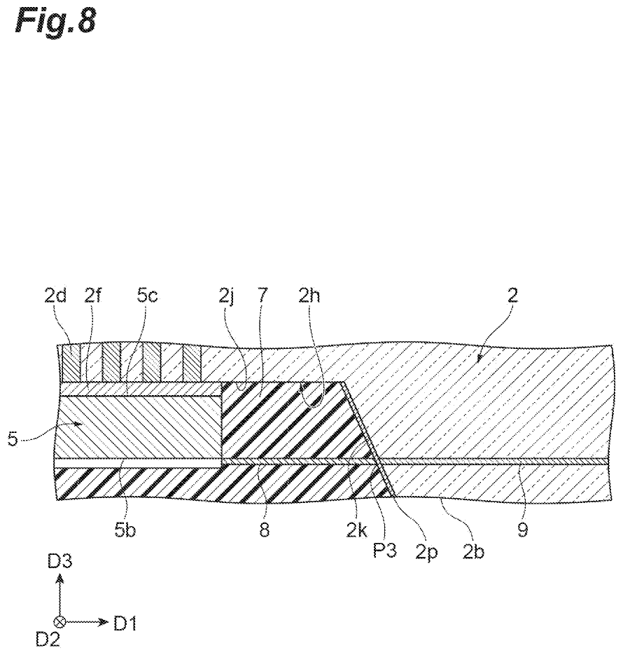

FIG. 8 shows an optical coupling portion P3 between the second waveguide 8 and the first waveguide 9 of the optical module according to a third modification example. In the third modification example, the inner surface 2k of the recessed portion 2h is inclined with respect to the optical axis of the second waveguide 8 and the optical axis of the first waveguide 9. Namely, the inner surface 2k is inclined with respect to the third direction D3. Incidentally, in the example of FIG. 8, the inner surface 2k is inclined with respect to the third direction D3 from the bottom surface 2j of the recessed portion 2h to the first surface 2b. However, the inner surface 2k may be inclined with respect to the third direction D3 at least at the optical coupling portion P3. In the example of FIG. 8, a cross section of the inner surface 2k when taken along a plane extending in both the first direction D1 and the third direction D3 has a linear shape. However, the cross section of the inner surface 2k may be curved.

As described above, when the inner surface 2k of the recessed portion 2h is inclined with respect to the third direction D3, the reflection of the optical signal L on the inner surface 2k can be suppressed. An inclination angle of the inner surface 2k with respect to the third direction D3 is, for example, 4° or more, and may be 8° or more. Accordingly, reflection loss can be reduced without increasing coupling loss at the optical coupling portion P3. In order to further reduce the reflection loss, the anti-reflection film 2p may be formed on the inner surface 2k. However, when the reflection is small or when the intensity of the optical signal L incident on the first waveguide 9 is at an acceptable level, the anti-reflection film 2p can be omitted. As in the present example, when the inner surface 2k is inclined with respect to the third direction D3, the inner surface 2k may be parallel to the second direction D2.

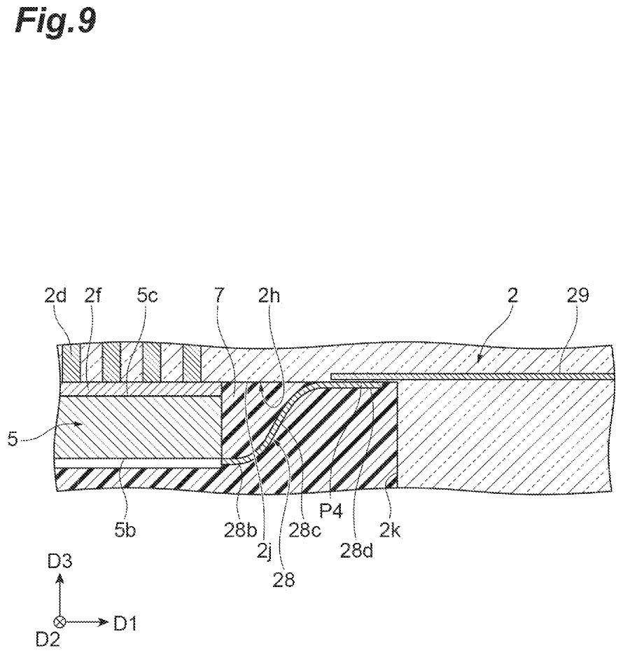

FIG. 9 shows an optical coupling portion P4 between a second waveguide 28 and a first waveguide 29 of the optical module according to a fourth modification example. At the optical coupling portion P4, the second waveguide 28 is optically coupled to the first waveguide 29 on the bottom surface 2j of the substrate 2. An end portion of the second waveguide 28 opposite to the optical element 5 is located on the bottom surface 2j. More specifically, the second waveguide 28 includes a first extension portion 28b extending from the optical element 5 along the first direction D1; a second extension portion 28c that bends from the first extension portion 28b toward the bottom surface 2j and that extends obliquely with respect to both the first direction D1 and the third direction D3; and a third extension portion 28d extending from an end portion of the second extension portion 28c opposite to the first extension portion 28b along the bottom surface 2j.

The first waveguide 29 extends along the bottom surface 2j inside the substrate 2. A distance between the first waveguide 29 and the bottom surface 2j of the recessed portion 2h of the substrate 2 is, for example, 1 μm. In a plan view, the second waveguide 28 and the first waveguide 29 include portions overlapping each other, and the optical coupling portion P4 is formed of the overlapping portions. A length of the second waveguide 28 at the optical coupling portion P4 and a length of the first waveguide 29 at the optical coupling portion P4 are, for example, 500 μm. The lengths correspond to a length of the optical coupling portion P4. With the above-described configuration, the first waveguide 29 is evanescently coupled (also referred to as thermal insulating coupling) to the second waveguide 28. The second waveguide 28 and the first waveguide 29 are optically coupled to each other with low loss by evanescent coupling.

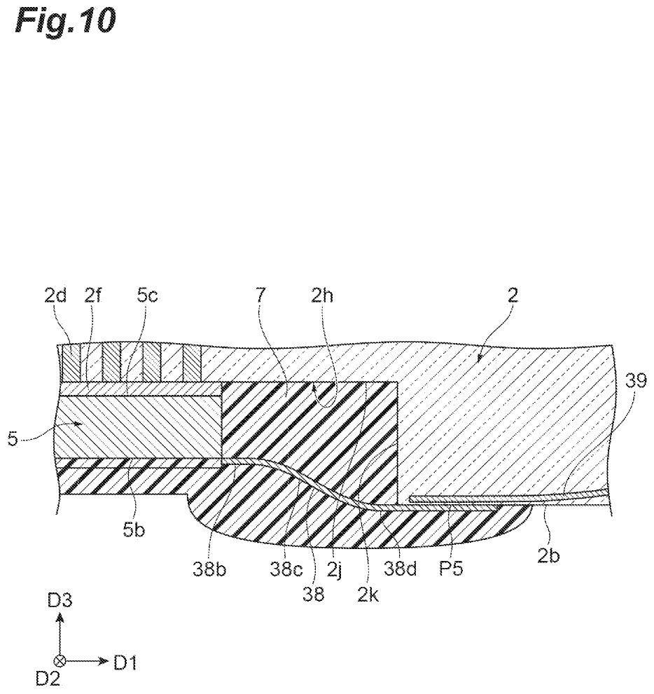

FIG. 10 shows an optical coupling portion P5 between a second waveguide 38 and a first waveguide 39 of the optical module according to a fifth modification example. At the optical coupling portion P5, the second waveguide 38 is optically coupled to the first waveguide 39 on the first surface 2b of the substrate 2. An end portion of the second waveguide 38 opposite to the optical element 5 is located on the first surface 2b. More specifically, the second waveguide 38 includes a first extension portion 38b extending from the optical element 5 along the first direction D1; a second extension portion 38c that bends from the first extension portion 38b toward the first surface 2b and that extends in such a manner as to incline in both the first direction D1 and the third direction D3; and a third extension portion 38d extending from an end portion of the second extension portion 38c opposite to the first extension portion 38b to the first surface 2b along the first direction D1.

The first waveguide 39 extends along the first surface 2b inside the substrate 2. The fifth modification example differs from the fourth modification example in that the location of evanescent coupling is the first surface 2b. Namely, the first waveguide 39 is evanescently coupled to the second waveguide 38 on the first surface 2b. However, in the fifth modification example, the resin layer 7 covering the second waveguide 38 is formed to the outside of the recessed portion 2h. For example, when the resin constituting the resin layer 7 is applied, a flow stopper may be formed using resin other than the resin such that the resin is prevented from leaking and spreading from the recessed portion 2h. For example, the other resin is photosensitive or thermosetting.

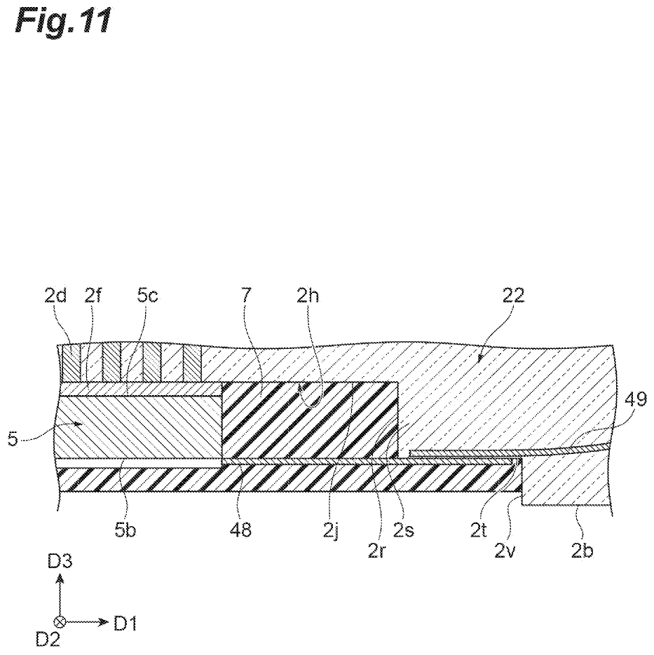

FIG. 11 shows a substrate 22, a second waveguide 48, and a first waveguide 49 according to a sixth modification example. The substrate 22 differs from the substrate 2 in that the recessed portion 2h includes a step portion 2s. The step portion 2s includes a first side surface 2rextending from the bottom surface 2j and extending in both the second direction D2 and the third direction D3; a step surface 2t extending from the first side surface 2r and extending in both the first direction D1 and the second direction D2; and a second side surface 2v extending from the step surface 2t and extending in both the second direction D2 and the third direction D3.

In the sixth modification example, the first waveguide 49 is evanescently coupled to the second waveguide 48 on the step surface 2t. For example, the second waveguide 48 extends along the first direction D1. The first waveguide 49 extends along the step surface 2t inside the substrate 22. In the case of the sixth modification example, the resin layer 7 can be kept inside the recessed portion 2h. Therefore, there is no need to form the flow stopper described above. Furthermore, a height of the resin layer 7 from the bottom surface 2j (a length in the third direction D3) can be made lower than a height of the first surface 2b from the bottom surface 2j.

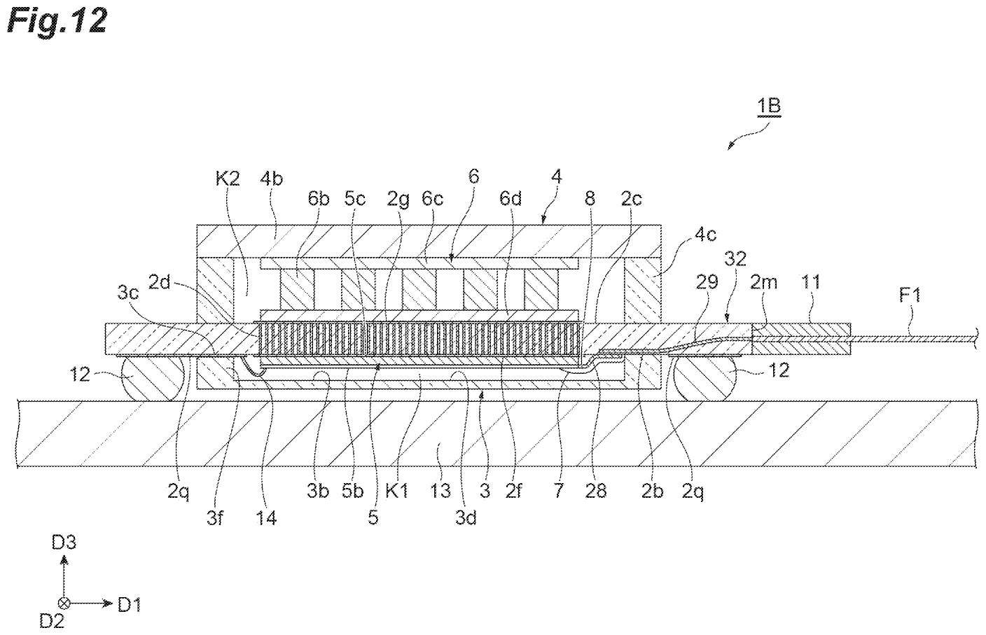

FIG. 12 is a cross-sectional view showing an optical module 1B according to a seventh modification example. FIG. 12 is a cross-sectional view of the optical module 1B when taken along a plane extending in both the first direction D1 and the third direction D3. The optical module 1B differs from the optical module 1A in that the optical module 1B includes a substrate 32 that does not include the recessed portion 2h.

In the optical module 1B, the optical element 5 is face-up mounted on the substrate 32 such that the first surface 5b which is a circuit surface faces opposite to the vias 2d of the substrate 32. The optical module 1B includes the second waveguide 28 and the first waveguide 29 that are evanescently coupled on the first surface 2b of the substrate 32. The optical module 1B includes the substrate 32 that does not include the recessed portion 2h, so that the strength of the substrate 32 can be improved and the occurrence of warpage or the like in the substrate 32 can be suppressed. Therefore, stable optical coupling between the second waveguide 28 and the first waveguide 29 is possible.

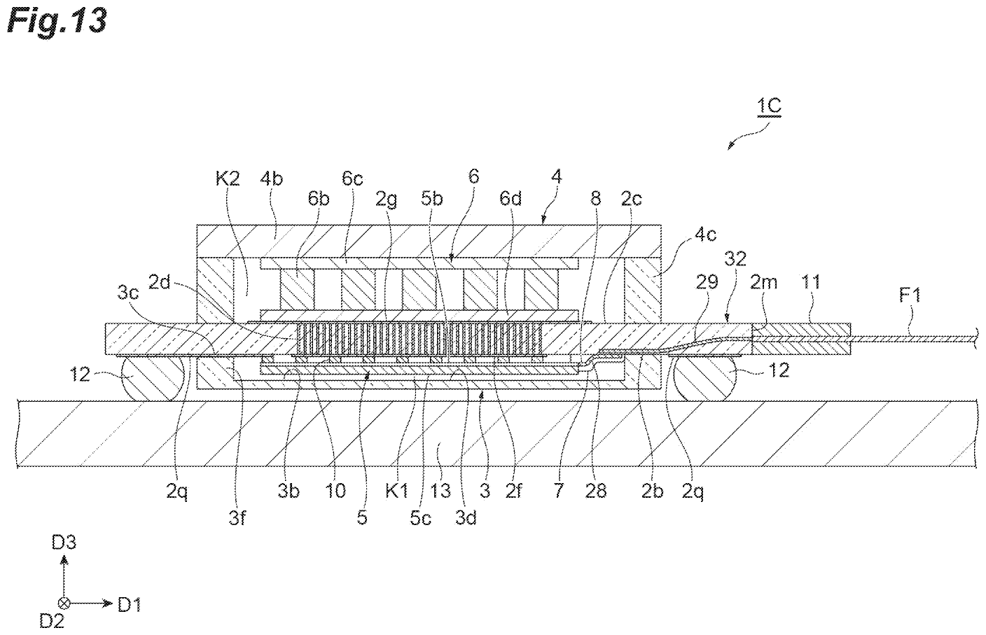

FIG. 13 is a cross-sectional view showing an optical module 1C according to an eighth modification example. In the optical module 1C, the optical element 5 is flip-chip mounted (face-down mounted) on the substrate 32 such that the first surface 5b which is a circuit surface faces the substrate 32. In the flip-chip mounting, for example, thermocompression or ultrasonic joining is used.

For example, the optical element 5 includes an electrode (pad) formed on the first surface 5b. For example, the electrode is thermally connected to the electrode 2f and the vias 2d formed on the first surface 2b of the substrate 32 through bumps 10, and is electrically connected to the electrical wiring 2q. For example, the bumps 10 are disposed in an array pattern in a plan view along the third direction D3. For example, the electrode formed on the first surface 5b may be a pad made of gold (Au). For example, each bump 10 is a solder bump, an Au stud bump, or a microbump in which a solder cap is placed on a pillar made of copper (Cu). A gap between the substrate 32 and the optical element 5 may be filled with an underfill resin.

As in the optical module 1C, even when the optical element 5 is face-down mounted, only the first surface 5b (circuit surface) of the optical element 5 is fixed to the substrate 32, and the second surface 5c (substrate surface) is not fixed. Therefore, thermal stress applied to the optical element 5 can be reduced. Incidentally, a recessed portion may be provided on the first surface 2b of the substrate 32, and the optical element 5 may be face-down mounted on a bottom surface of the recessed portion.

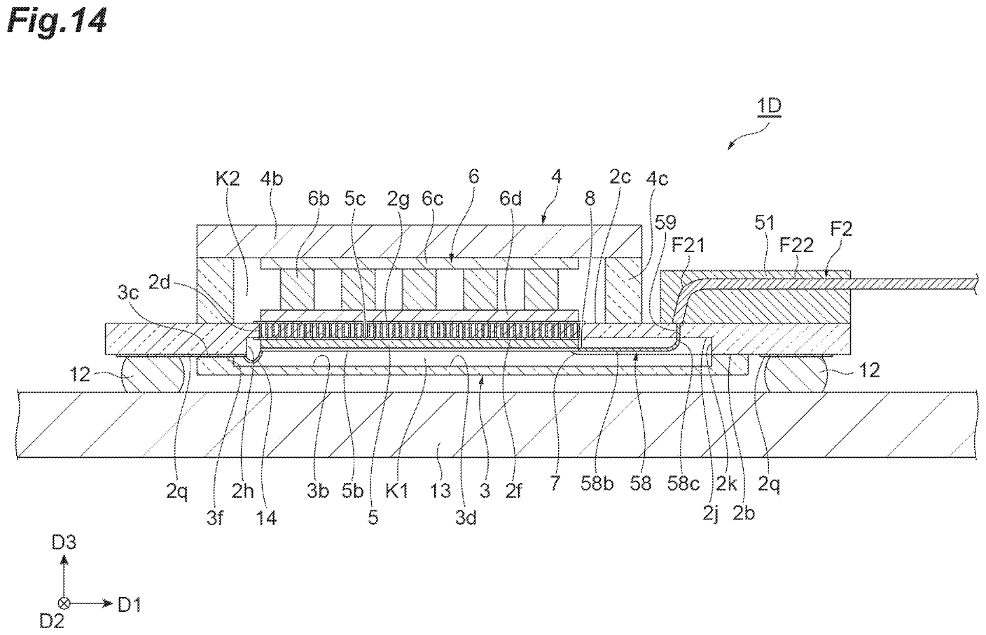

FIG. 14 is a cross-sectional view showing an optical module 1D according to a ninth modification example. The optical module 1D differs from the optical module 1A in a configuration of an optical fiber F2, an optical fiber array 51, a second waveguide 58, and a first waveguide 59. In the optical module 1D, the second waveguide 58 and the first waveguide 59 are optically coupled on the bottom surface 2j of the recessed portion 2h of the substrate 2 by edge coupling. The second waveguide 58 includes an extension portion 58b extending from the end surface of the optical element 5 along the first direction D1, and a curved portion 58c that bends toward the bottom surface 2j from an end portion of the extension portion 58b opposite to the optical element 5. At the curved portion 58c, the second waveguide 58 is bent at approximately 90° from the first direction D1 to the third direction D3. In the second waveguide 58, it is easy to increase the difference in relative refractive index between a core and a cladding and to reduce the core diameter compared to the first waveguide 59, so that low-loss optical coupling is possible due to the second waveguide 58 including the curved portion 58c. Incidentally, the bending angle of the curved portion 58c may not be 90°.

The first waveguide 59 penetrates between the first surface 2b and the second surface 2c. Namely, the first waveguide 59 extends from the bottom surface 2j of the recessed portion 2h to the second surface 2c of the substrate 2. Incidentally, the glass portion of the substrate 2 may be interposed between an end surface of the first waveguide 59 and the bottom surface 2j and between an end surface of the first waveguide 59 and the second surface 2c. An optical axis of the first waveguide 59 may extend perpendicularly to the bottom surface 2j of the recessed portion 2h (along the third direction D3), or may extend obliquely with respect to the third direction D3. When the optical axis of the first waveguide 59 extends obliquely with respect to the third direction D3, reflection loss at optical coupling between the second waveguide 58 and the optical fiber array 51 can be further reduced. An anti-reflection film may be formed on the bottom surface 2j of the recessed portion 2h.

The optical fiber array 51 is optically coupled to the first waveguide 59 on the second surface 2c of the substrate 2. Incidentally, an adhesive may be interposed between the second surface 2c of the substrate 2 and the optical fiber array 51. The optical fiber F2 is bent at approximately 90° in the optical fiber array 51. The optical fiber F2 includes a curved portion F21 that extends from the first waveguide 59 and that bends from the third direction D3 to the first direction D1, and an extension portion F22 extending from an end portion of the curved portion F21 opposite to the first waveguide 59 along the first direction D1. The optical fiber F2 is bent at approximately 90° at the curved portion F21. However, the bending angle at the curved portion F21 may not be 90°. Furthermore, the optical fiber F2 may not be bent.

In the optical module 1D, the first waveguide 59 and the optical fiber array 51 are optically coupled to each other on the second surface 2c of the substrate 2. In this case, optical coupling is possible over a wider area compared to optical coupling on the outer surface 2m of the substrate 2. As a result, the reliability of optical coupling can be improved. Incidentally, an optical component (for example, a lens, a mirror, an isolator, a multi/demultiplexer, a filter, or the like) other than the optical fiber array 51 may be mounted on the second surface 2c of the substrate 2, and the optical component may be optically coupled to the first waveguide 59 and the optical fiber array 51.

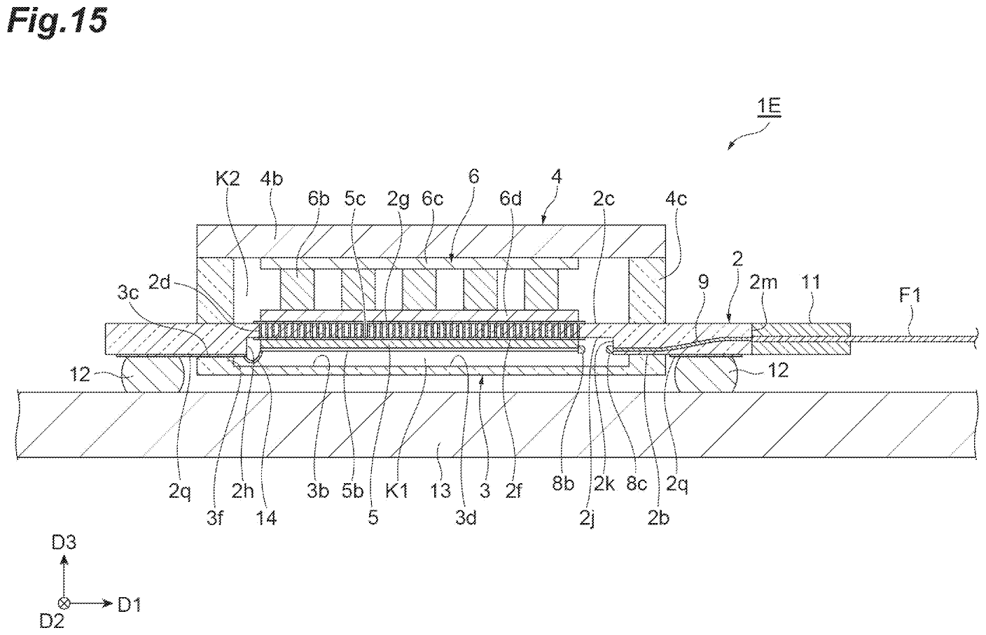

FIG. 15 is a cross-sectional view showing an optical module 1E according to a tenth modification example. The optical module 1E differs from the optical module 1A in that the optical module 1E includes a first lens 8b and a second lens 8c instead of the second waveguide 8. The first lens 8b is formed on the end surface of the optical element 5, and the second lens 8c is formed on the inner surface 2k of the recessed portion 2h. For example, the first lens 8b is a collimating lens. The first lens 8b converts the optical signal L output from the end surface of the optical waveguide of the optical element 5 into collimated light. For example, the second lens 8c is a condensing lens. The second lens 8c focuses the collimated light output from the first lens 8b onto the end surface of the first waveguide 9, and causes the collimated light to be incident on the first waveguide 9.

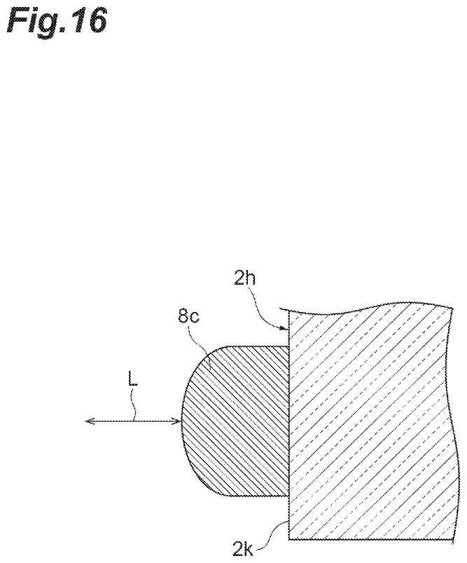

FIG. 16 is an enlarged view of the second lens 8c. As shown in FIGS. 15 and 16, the second lens 8c has, as one example, a U-shape protruding from the inner surface 2k of the recessed portion 2h. The first lens 8b has a U-shape protruding from the end surface of the optical element 5. In the optical module 1E, the second lens 8c is provided on the substrate 2, and the first lens 8b that is optically coupled to the second lens 8c is provided on the optical element 5. The optical signal L is input to and output from the outside of the optical module 1E through the first lens 8b, the second lens 8c, and the first waveguide 9. Therefore, since the optical element 5 is optically coupled to the outside of the optical module 1E through the first lens 8b, the second lens 8c, and the first waveguide 9, the input and output of the optical signal L can be appropriately performed.

In the optical module 1E, optical coupling between the optical element 5 and the first waveguide 9 is made by collimated light, so that high-accuracy alignment when the optical element 5 is mounted on the substrate 2 can be made unnecessary and low-loss optical coupling can be maintained when the substrate 2 is deformed due to a change in temperature. In addition, in the case of the optical module 1E including the first lens 8b and the second lens 8c, since there is no need to physically connect the end surface of the optical element 5 and the inner surface 2k of the recessed portion 2h, the reliability of optical coupling can be improved. Furthermore, the resin layer 7 described above can be made unnecessary. For example, the first lens 8b and the second lens 8c can be formed in the same manner as the second waveguide 8 described above.

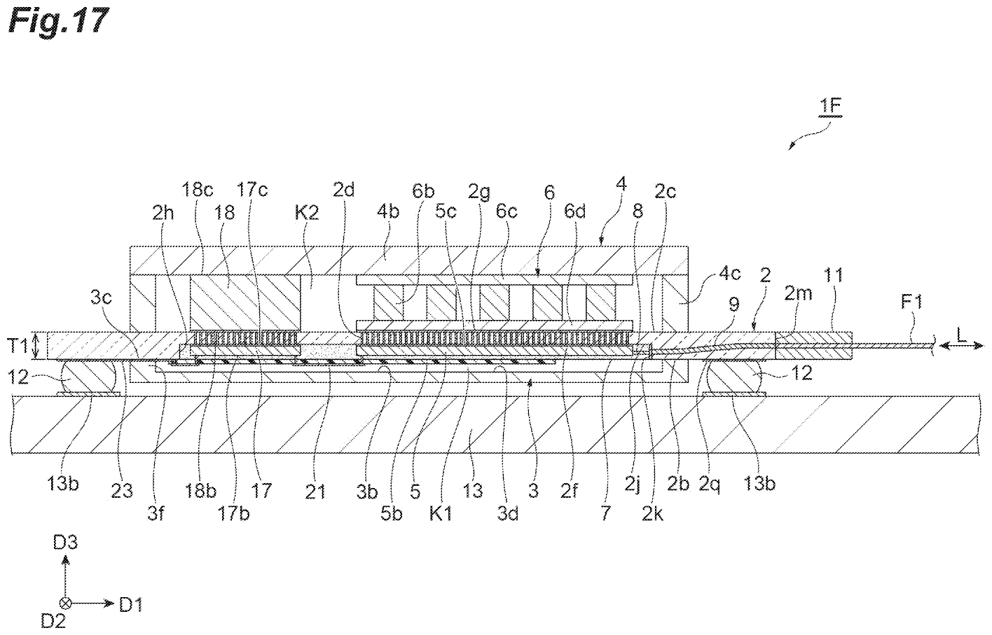

FIG. 17 is a cross-sectional view showing an optical module 1F according to an eleventh modification example. The optical module 1F differs from the optical module 1A in that the optical module 1F includes an electrical element 17 provided on the first surface 2b of the substrate 2 (inside the recessed portion 2h), and a thermally conductive member 18 provided on the second surface 2c of the substrate 2. For example, the electrical element 17 is a semiconductor circuit component formed by a SiGe BiCMOS process. The electrical element 17 is, for example, a driver IC that drives the optical element 5. The electrical element 17 may be, for example, a transimpedance amplifier (receiver IC) that converts an electrical signal, which is output from the optical element 5 that is a photodiode, into a voltage to amplify the voltage. In addition, the electrical element 17 may include both a driver IC and a transimpedance amplifier. As one example, a length of the electrical element 17 in the first direction D1 is 2 mm, and a length of the electrical element 17 in the second direction D2 is 4 mm. A length (thickness) of the electrical element 17 in the third direction D3 is, for example, 0.1 mm.

The electrical element 17 has, for example, a first surface (circuit surface) 17b on which an electrical circuit is formed, and a second surface (substrate surface) 17c facing opposite to the first surface 17b. For example, an active element such as a transistor, an electrical wiring, or a pad is formed on the first surface 17b. The pad of the electrical element 17 is made of, for example, aluminum (Al). For example, a passive element such as an electrode may be formed on the second surface 17c. The electrical element 17 is face-up mounted inside the recessed portion 2h to face the substrate 2. The second surface 17c of the electrical element 17 is thermally connected to the electrode 2f and the vias 2d formed on the bottom surface 2j of the recessed portion 2h. Thermal connection between the second surface 17c and each of the electrode 2f and the vias 2d is performed using, for example, a silver paste.

The thermally conductive member 18 is, for example, a heat dissipation block. The thermally conductive member 18 is sandwiched between the heat dissipation member 4b and the substrate 2. The thermally conductive member 18 is thermally connected to the heat dissipation member 4b. The thermally conductive member 18 is made of, for example, aluminum nitride (AlN). The thermally conductive member 18 has, for example, a first surface 18b that comes into contact with the electrode 2g of the substrate 2, and a second surface 18c that comes into contact with the heat dissipation member 4b. A thermal interface material may be interposed at least one of between the first surface 18b and the electrode 2g and between the second surface 18c and the heat dissipation member 4b. For example, a length of the thermally conductive member 18 in the first direction D1 is 2 mm, and a length of the thermally conductive member 18 in the second direction D2 is 4 mm. A length (thickness) of the thermally conductive member 18 in the third direction D3 is, for example, 1 mm.

The electrical element 17 is thermally connected to the thermally conductive member 18 through the electrode 2f, the vias 2d, and the electrode 2g of the substrate 2. Materials other than the electrode 2f and the electrode 2g around the electrical element 17 are materials with low thermal conductivity such as gas, resin, and glass. The electrical element 17 is, as will be described later, connected to an electrical wiring 21, and the electrical wiring 21 has high thermal resistance due to having a thin thickness of approximately 3 μm. The electrical element 17 is thermally floated (thermally insulated) except for the vias 2d, and heat is efficiently dissipated from the electrical element 17 by the thermally conductive member 18. For example, a thermal resistance between the electrical element 17 and the thermally conductive member 18 is one or more orders of magnitude lower than a thermal resistance between the electrical element 17 and the outside of the optical module 1F.

The second surface 17c (substrate surface) of the electrical element 17 is fixed to the substrate 2, and is physically connected to the thermally conductive member 18. The first surface 17b (circuit surface) of the electrical element 17 may be in contact only with a component having high elasticity such as resin. In this case, similarly to the optical element 5, compared to a configuration in which both the circuit surface and the substrate surface are fixed, the influence of stress on the electrical element 17 caused by a change in temperature can be suppressed. As a result, the reliability of the electrical element 17 and the optical module 1F is improved.

The optical module 1F includes the electrical wiring 21 that electrically connects the electrical element 17 to the optical element 5. The electrical wiring 21 transmits, for example, an electrical signal (high-speed signal), which is modulated at high speed (for example, the modulation rate is 200 GBd), between the electrical element 17 and the optical element 5. The electrical wiring 21 forms a transmission line for transmitting a high-speed signal, and has an appropriately designed characteristic impedance. By forming a transmission line using the electrical wiring 21, the distance from the optical element 5 to the electrical element 17 can be increased (for example, 1 mm apart). In this case, the inflow of heat from the electrical element 17 to the optical element 5 can be reduced by increasing the thermal resistance of the electrical wiring 21. Furthermore, when the electrical wiring 21 is provided, the influence of parasitic inductance of the electrical wiring can be reduced compared to wire bonding.

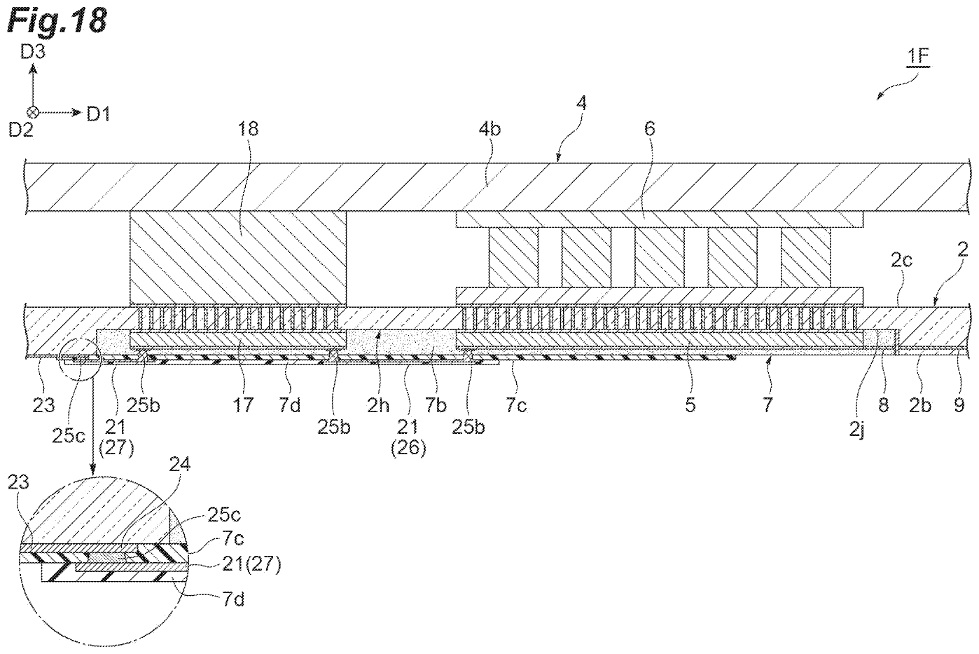

FIG. 18 is an enlarged view of a structure around the optical element 5 and the electrical element 17 of FIG. 17. As shown in FIGS. 17 and 18, the optical module 1F includes an electrical wiring 23 formed on the first surface 2b of the substrate 2. The electrical wiring 23 is made of, for example, copper (Cu) or gold (Au). When the electrical wiring 23 is made of copper, the surface of the electrical wiring 23 may be plated with gold (Au). An insulating layer may be formed between the electrical wiring 23 and the substrate 2. In addition, the electrical wiring 23 may be covered with an insulating film (protection film). For example, the electrical wiring 23 includes a pad 24. As described above, when the electrical wiring 23 is covered with an insulating film (protection film), the insulating film is removed at the portion of the pad 24.

The optical module 1F includes the resin layer 7 that embeds the optical element 5 and the electrical element 17. For example, the resin layer 7 includes a first resin layer 7b that comes into contact with the bottom surface 2j of the recessed portion 2h; a second resin layer 7c located on an opposite side of the first resin layer 7b from the bottom surface 2j; and a third resin layer 7d located opposite to the first resin layer 7b when viewed from the second resin layer 7c.

The first resin layer 7b is formed to fill the recessed portion 2h. The first resin layer 7b embeds the optical element 5 and the electrical element 17 in the recessed portion 2h. However, the first resin layer 7b is open at vias 25b to be described later. Resin constituting the first resin layer 7b is, for example, a photosensitive polymer. As one example, the recessed portion 2h is filled with the resin in a liquid state such that the optical element 5 and the electrical element 17 disposed in the recessed portion 2h are embedded. Thereafter, the resin is exposed, developed, and baked (cured). A thickness (a length in the third direction D3) of the first resin layer 7b is, for example, substantially the same as the depth (a length in the third direction D3) of the recessed portion 2h. In this case, the surface of the first resin layer 7b (surface opposite to the bottom surface 2j of the recessed portion 2h) is flush with the first surface 2b. However, the thickness of the first resin layer 7b may be thicker or thinner than the depth of the recessed portion 2h.

The second resin layer 7c is formed on the first resin layer 7b. The second resin layer 7c covers the pad 24 of the electrical wiring 23, an electrode of the electrical element 17, and the electrode of the optical element 5, and is open at the vias 25b and a via 25c. Resin constituting the second resin layer 7c is, for example, a photosensitive polymer. The resin may be applied to the first resin layer 7b in a liquid state, or may be laminated onto the first resin layer 7b in a film state. Thereafter, the resin is exposed, developed, and baked to form the second resin layer 7c. Incidentally, the second resin layer 7c may be omitted. In this case, the first resin layer 7b may be integrated with the second resin layer 7c to cover the pad 24 of the electrical wiring 23, the electrode of the electrical element 17, and the electrode of the optical element 5. Then, the electrical wiring 21 may be formed on the first resin layer 7b.

The electrical wiring 21 is, for example, a metal film formed on the second resin layer 7c, and is made of, for example, copper (Cu). The electrical wiring 21 is formed, for example, by a plating process such as a semi-additive method, and is also referred to as a redistribution layer (RDL). A plurality of the electrical wirings 21 include an electrical wiring 27 that electrically connects the pad 24 of the electrical wiring 23 and the electrode of the electrical element 17 to each other, and an electrical wiring 26 that electrically connects the electrode of the electrical element 17 and the electrode of the optical element 5 to each other.

For example, the electrical element 17 receives an electrical signal, which is input to the terminals 12 from the outside of the optical module 1F, through the electrical wiring 27, and outputs a drive signal generated according to the electrical signal to the optical element 5 through the electrical wiring 26. In the first direction D1, the electrical element 17 is disposed between the terminals 12 and the optical element 5. In addition, for example, the electrical element 17 receives a reception signal generated according to the optical signal L from the optical element 5 through the electrical wiring 26, and outputs an electrical signal generated according to the reception signal to the terminals 12 through the electrical wiring 27.

The optical module 1F includes, for example, the vias 25b for access to the electrode of the optical element 5 and the electrode of the electrical element 17, and the via 25c for access to the electrical wiring 23. Each of the vias 25b and the via 25c is formed of, for example, a via hole formed by irradiation with a laser beam and an electrical wiring formed in the via hole. The electrical wirings of the vias 25b may be formed separately from the electrical wirings 21, or may be formed together (collectively) with the electrical wirings 21. Each via 25b may be a filled via of which the inside is filled with a conductive material, or may be a conformal via of which the inside is not filled with a conductive material. The same applies to the via 25c.

The third resin layer 7d covers the electrical wirings 21 to protect the electrical wirings 21. Therefore, the electrical wirings 21 are formed between the second resin layer 7c and the third resin layer 7d. Resin constituting the third resin layer 7d is, for example, a photosensitive polymer. The resin may be applied to the second resin layer 7c in a liquid state, or may be laminated onto the second resin layer 7c in a film state. Thereafter, the resin is exposed, developed, and baked to form the third resin layer 7d. Incidentally, the third resin layer 7d may be omitted.

For example, the optical module IF includes the second waveguide 8 extending from the optical element 5 to the first waveguide 9 of the substrate 2 in the first resin layer 7b. The second waveguide 8 may be formed, for example, before the recessed portion 2h is filled with the first resin layer 7b. Refractive indexes of the second waveguide 8 and the first resin layer 7b are, for example, 1.3 or more and 1.7 or less in the wavelength band of the optical signal L. The second waveguide 8 has a refractive index larger than the refractive index of the first resin layer 7b. In this case, the first resin layer 7b functions as a cladding in the optical waveguide for the optical signal L input to and output from the optical element 5, and the optical signal L is confined inside the second waveguide 8 functioning as a core layer. For example, the second waveguide 8 and the first resin layer 7b are transmissive for the wavelength band of the optical signal L used by the optical module 1F.

For example, a linear expansion coefficient of the resin constituting the first resin layer 7b is smaller than a linear expansion coefficient of the resin constituting the second waveguide 8. In this case, the influence of thermal expansion or thermal contraction of the first resin layer 7b, which has a larger volume than the second waveguide 8, on optical coupling between the optical element 5 and the first waveguide 9 by the second waveguide 8 (for example, a decrease in optical coupling efficiency) can be reduced. With such a configuration, the optical element 5 can transmit and receive the optical signal L to and from the outside of the optical module 1F through the second waveguide 8 and the first waveguide 9.

For example, the second resin layer 7c is spaced apart from the second waveguide 8. Namely, the position of the second resin layer 7c in the first direction D1 is different from the position of the second waveguide 8 in the first direction D1. In this case, the influence of thermal expansion or thermal contraction of the second resin layer 7c on the optical coupling between the optical element 5 and the first waveguide 9 by the second waveguide 8 can be reduced.

An example in which the first resin layer 7b is used as the cladding of the second waveguide 8 has been described above. However, resin other than the first resin layer 7b may be used as the cladding of the second waveguide 8. For example, a region including an optical coupling portion between the optical element 5 and the first waveguide 9 may be filled with resin other than the first resin layer 7b, and the resin may function as the cladding of the second waveguide 8. In addition, when air having a refractive index of approximately 1 can be used as the cladding, the periphery of the second waveguide 8 may not be covered with resin.

For example, the electrical wiring 26 includes a signal wiring for transmitting a high-speed signal (high-frequency signal), and the signal wiring forms a transmission line. When the optical element 5 is an IQ modulator, for impedance matching, a characteristic impedance of the electrical wiring 26 may be substantially equal to the resistance value of a high-frequency wiring (transmission line) formed in the optical element 5 and a terminating resistor, and for example, a differential impedance is 50 Ω to 60 Ω. “Being substantially equal” indicates that the values may differ within a practically acceptable range.

For example, the electrical wiring 27 includes a signal wiring for transmitting a high-speed signal (high-frequency signal), and the signal wiring forms a transmission line. For impedance matching, a characteristic impedance of the electrical wiring 27 may be substantially equal to the resistance value of a terminating resistor formed in the electrical element 17 connected to the electrical wiring 27, and for example, a differential impedance is 100 Ω. The characteristic impedance of the electrical wiring 27 may be different from the characteristic impedance of the electrical wiring 26.

For example, the electrical wirings 26 are aligned along the second direction D2 in a plan view of the substrate 2. An interval (pitch) of two electrical wirings 26 aligned along the second direction D2 is, for example, 100 μm. A width of the electrical wiring 26 is, for example, 95 μm. A distance between two electrical wirings 26 adjacent to each other along the second direction D2 is, for example, 5 μm. In such a manner, a plurality of the electrical wirings 26 are formed at high density. Therefore, electrical connection between the optical element 5 and the electrical element 17 can be performed with high density. For example, a relative permittivity of the resin layer 7 is lower than a relative permittivity of ceramic. As one example, the relative permittivity of the resin layer 7 is 3.3. In this case, a cutoff frequency that allows stable signal transmission in the electrical wirings 26 can be made higher than that of a ceramic package. Therefore, the optical module 1F can be used up to a higher frequency band (for example, 100 GHz or more).

Signals that transmit through the electrical wirings 26 are formed of, for example, differential signals. As one example, the signals that transmit through the electrical wirings 26 are formed of, for example, four channels of differential signals. The number of the electrical wirings 26 is, for example, 16 in total for four channels. The electrical wiring 26 is, for example, a ground-signal-signal-ground (GSSG) line. However, the electrical wiring 26 may be a ground-signal-ground-signal-ground (GSGSG) line. The electrical wiring 26 is, for example, a coplanar line designed as a single-layer Cu wiring. By forming the electrical wiring 26 in a single layer, the thermal resistance of the electrical wiring 26 can be increased. A characteristic impedance of the coplanar line may be matched to, for example, the terminating resistance of the optical element 5 for impedance matching. The characteristic impedance is, for example, 50 Ω to 60 Ω.

A thickness of the Cu wiring of the electrical wiring 26 described above is, for example, 3 μm. The thermal conductivity of copper (Cu) is approximately 400 [W/(m·K)], and when a cross-sectional area of the electrical wiring 26 is 285 μm² (width 95 μm×thickness 3 μm), and the distance from the optical element 5 to the electrical element 17 is 1 mm, the total thermal resistance of the 16 electrical wirings 26 is as large as approximately 550 [K/W]. In addition, the thermal resistance of the resin layer 7 from the optical element 5 to the electrical element 17 is large since the thermal conductivity of the resin is 1 [W/(m·K)] or less. Therefore, parallel thermal resistance from the optical element 5 to the electrical element 17 is also large. The parallel thermal resistance is, for example, 100 times or more larger than a thermal resistance (approximately 1.6 [K/W] obtained from (the assumption that the area of the electrical element 17 is 4 mm×2 mm, the thickness of the substrate 2 is 0.5 mm, and the thermal conductivity of the portion of the vias 2d is 40 [W/(m·K)])) of the thermal vias (vias 2d) of the substrate 2 thermally connected to the electrical element 17 that is a heat generating body. Therefore, the outflow and inflow of heat between the electrical element 17 and the optical element 5 can be effectively reduced.

Incidentally, the configuration of the electrical wirings 26 is not limited to the above example. For example, the electrical wiring 26 may be a microstrip line or a grounded coplanar line designed as a two-layer Cu wiring. The optical module 1F may include a power supply line or a control line (relatively low-speed electrical signal) other than the electrical wirings 26 between the optical element 5 and the electrical element 17. Furthermore, the optical module 1F may include, for example, a shield (a metal cover connected to a ground potential) on the outer side of the first sealing member 3 for EMI countermeasure.

The optical module 1F includes the electrical wiring 23 formed on the first surface 2b of the substrate 2, and the terminals 12 for external connection that are electrically connected to the electrical wiring 23. The terminals 12 and the electrical wirings 23 are provided, for example, to input and output high-speed signals to and from the electrical element 17. The signals that transmit through the terminals 12 and the electrical wirings 23 are formed of, for example, differential signals. As one example, the signals that transmit through the terminals 12 and the electrical wirings 23 are formed of, for example, four channels of differential signals. The number of the electrical wirings 23 is, for example, 16 in total for four channels. The electrical wiring 23 is, for example, a ground-signal-signal-ground (GSSG) line. The electrical wiring 23 is, for example, a transmission line (for example, a coplanar line) designed as a single-layer Cu wiring. For example, for impedance matching, a characteristic impedance of the transmission line may be matched to the terminating resistance of the electrical element 17 to which the electrical wiring 23 is connected, and a differential impedance is, for example, 100 Ω.

An interval (pitch) of the electrical wirings 23 is, for example, 100 μm. A width of the electrical wiring 23 is, for example, 80 μm. A distance between two electrical wirings 23 adjacent to each other along the second direction D2 is, for example, 20 μm. In such a manner, a plurality of the electrical wirings 23 are formed on the substrate 2 at high density. Therefore, electrical connection between the electrical element 17 and the outside of the optical module 1F can be performed with high density. For example, a relative permittivity of the substrate 2 is lower than the relative permittivity of ceramic. As one example, the relative permittivity of the substrate 2 is 5.5. In this case, a cutoff frequency that allows stable signal transmission in the electrical wirings 23 can be made higher than that of a ceramic package. Therefore, the optical module 1F can be used up to a higher frequency band (for example, 100 GHz or more).

The terminal 12 may be a microbump. For example, as the terminal 12, a controlled collapse chip connection (C4) bump made of solder or a copper (Cu) pillar with solder formed at a tip portion can be used. For example, a diameter of the C4 bump is 100 μm. For example, a diameter of the Cu pillar is 40 μm, and a height of the Cu pillar is 50 μm.

Since the size of the terminal 12 is smaller when the terminal 12 is a microbump such as a C4 bump or a Cu pillar compared to when the terminal 12 is a BGA solder ball, the parasitic capacitance and the parasitic inductance are also reduced, so that high-frequency signal transmission becomes possible. However, when the terminal 12 is a microbump, the height (length in the third direction D3) of the terminal 12 is smaller than the height of the first sealing member 3. Therefore, when the optical module 1F is mounted on another substrate, a recessed portion or a through-hole may be provided at a position that the first sealing member 3 faces. The optical module 1F has been described above. In the optical module 1F, at least one of the first sealing member 3, the second sealing member 4, and the temperature control element 6 can be omitted. For example, when the optical element 5 and the second waveguides 8 can be protected from moisture or a trace amount of gas, which is generated from other components, by the resin layer 7 or by further forming a protection film so as to cover the resin layer 7, the first sealing member 3 may be omitted. In addition, when there is no risk of dew condensation on the temperature control element 6, the second sealing member 4 may be omitted. In that case, instead of the heat dissipation member 4b, an external heat dissipation member may be connected to the thermally conductive member 18 and the temperature control element 6 to dissipate heat. In the optical module 1F, the optical element 5 and the electrical element 17 are embedded in the resin layer 7, and the optical element 5 and the electrical element 17 are electrically connected to each other and the electrical element 17 and the electrical wirings 23 of the substrate 2 are electrically connected to each other by electrical wirings 21. However, without using the resin layer 7, the optical element 5 and the electrical element 17 may be electrically connected to each other and the electrical element 17 and the electrical wirings 23 of the substrate 2 may be electrically connected to each other, for example, using a wiring substrate (bridge chip) on which transmission lines are formed. In such a manner, the method for integrating the optical element 5 and the electrical element 17 can be changed as appropriate.

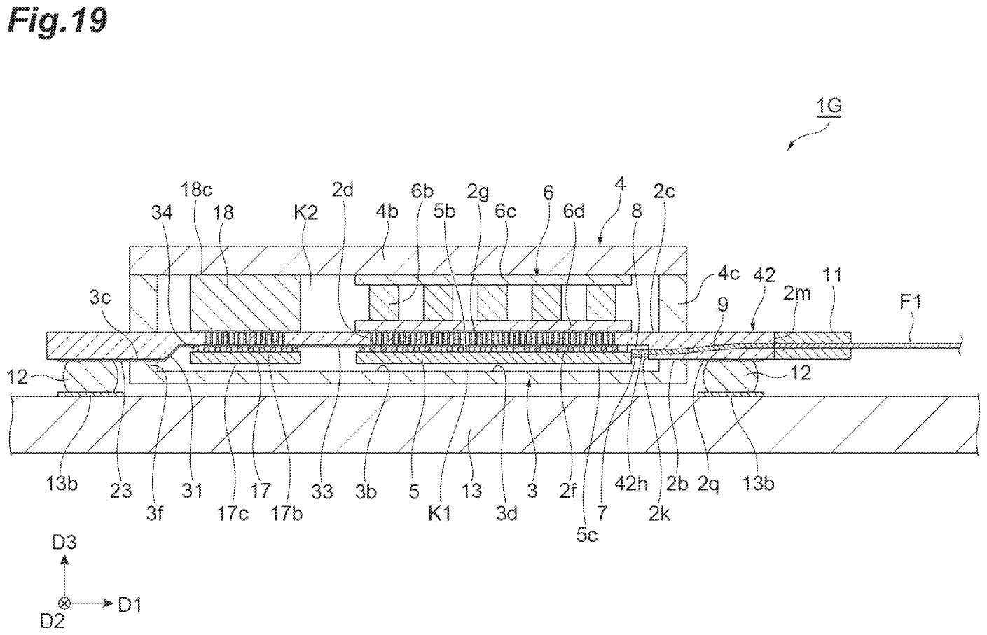

FIG. 19 is a cross-sectional view showing an optical module 1G according to a twelfth modification example. The optical module 1G differs from the optical module 1A in that the optical module 1G includes a substrate 42 and the optical element 5 and the electrical element 17 are face-down mounted on the substrate 42. In the optical module 1G, the electrical element 17 is mounted on the substrate 42 such that the first surface 17b (circuit surface) faces the substrate 42 in a recessed portion 42h formed on the substrate 42.

For example, the electrical element 17 includes an electrode formed on the first surface 17b, and the electrode is thermally connected to the electrode 2f and the vias 2d formed on the first surface 2b of the substrate 42 through bumps 34, and is electrically connected to an electrical wiring 31 and an electrical wiring 33. A gap between the electrical element 17 and the substrate 42 may be filled with an underfill resin. The electrical element 17 is thermally connected to the thermally conductive member 18 through the electrode 2f and the vias 2d of the substrate 42. The electrical element 17 is thermally floated (thermally insulated) except for the above-described thermal connection, and heat is efficiently dissipated from the electrical element 17 by the thermally conductive member 18.

The first surface 17b of the electrical element 17 is fixed to the substrate 42, and is physically connected to the thermally conductive member 18. On the other hand, the second surface 17c of the electrical element 17 is not fixed. Therefore, similarly to the optical element 5, compared to a configuration in which both the first surface and the second surface are fixed, the influence of stress on the electrical element 17 caused by a change in temperature can be suppressed. Accordingly, the reliability of the electrical element 17 and the optical module 1G is improved.

The optical module 1G includes the electrical wiring 33 that electrically connects the optical element 5 and the electrical element 17 to each other. The electrical wiring 33 forms a transmission line for transmitting a high-speed signal between the electrical element 17 and the optical element 5. The optical module 1G includes the electrical wiring 31 extending from the bump 34 to the outside of the first sealing member 3 in the recessed portion 42h. The electrical wiring 31 extends from a bottom surface of the recessed portion 42h to the outside of the recessed portion 42h.

The terminal 12 is connected to a portion of the electrical wiring 31 located outside the first sealing member 3. The electrical wiring 31 forms a transmission line for transmitting a high-speed signal between the electrical element 17 and the outside of the optical module 1G. For example, a portion of an inner surface of the recessed portion 42h on which the electrical wiring 31 is formed is inclined with respect to the third direction D3. In this case, loss of a high-frequency signal due to reflection or crosstalk can be reduced. Incidentally, in the optical module 1G, the recessed portion 42h of the substrate 42 can be omitted. In this case, the optical element 5 and the electrical element 17 are mounted on the first surface 2b of the substrate 42.

FIG. 20 is a cross-sectional view showing an optical module 1H according to a thirteenth modification example. The optical module 1H differs from the optical module 1A in that the optical module 1H includes a second electrical element 61 in addition to the optical element 5 and the electrical element 17. The second electrical element 61 is, for example, flip-chip mounted on the second surface 2c of the substrate 2. The second electrical element 61 is, for example, a digital signal processor (DSP). In this case, the second electrical element 61 has a SERDES function that performs mutual conversion between a parallel signal and a serial signal, an error correction function, an equalizer function, and an analog-to-digital conversion function.

The second electrical element 61 has a first surface 61b facing the substrate 2, and a second surface 61c facing opposite to the first surface 61b. The optical module 1H includes an electrode 62 that electrically connects the second electrical element 61 to the substrate 2. The electrode 62 is, for example, a microbump described above. The second electrical element 61 transmits and receives parallel signals (as one example, 100 channels of 8 GBd modulated signals) to and from the outside of the substrate 2 through the electrode 62.

The optical module 1H includes terminals 63 for external connection; a first substrate portion 64 to which the terminals 63 are fixed; and a second substrate portion 65 interposed between the first substrate portion 64 and the substrate 2. The optical module 1H forms a multilayer substrate including the first substrate portion 64 and the second substrate portion 65. For example, the first substrate portion 64 and the second substrate portion 65 are formed of electrical wirings extending along respective in-plane directions of the first substrate portion 64 and the second substrate portion 65, and insulating layers including vias extending along the third direction D3. The electrode 62 of the second electrical element 61 and the terminals 63 are electrically connected by the electrical wirings formed on the substrate 2, the first substrate portion 64, and the second substrate portion 65.

Incidentally, in the optical module 1H, the configuration of the substrate portions is not limited to that of the first substrate portion 64 and the second substrate portion 65, and can be changed as appropriate. Namely, the optical module 1H may not include one of the first substrate portion 64 and the second substrate portion 65, or may further include another substrate portion in addition to the first substrate portion 64 and the second substrate portion 65. The first substrate portion 64 and the second substrate portion 65 are, for example, glass substrates. However, the optical module 1H may include an organic insulating film made of polymer or the like, instead of the first substrate portion 64 and the second substrate portion 65.

The second electrical element 61 transmits and receives, for example, serial signals (as one example, four channels of 200 GBd modulated signals) to and from the electrical element 17 through the electrode 62, the electrical wiring 66 formed on the second surface 2c of the substrate 2, the electrical wiring (via) 67 connecting the second surface 2c and the first surface 2b of the substrate 2 to each other, and an electrical wiring 68 formed on the first surface 2b of the substrate 2. For example, the second electrical element 61 converts parallel signals, which are received from the outside of the substrate 2, into serial signals, and transmits the serial signals to the electrical element 17.

In addition, the second electrical element 61 converts, for example, serial signals, which are received from the electrical element 17, into parallel signals, and transmits the parallel signals to the outside of the substrate 2. The second electrical element 61 transmits and receives signals to and from the outside of the optical module 1H using parallel signals that are slower than serial signals, so that the speed of signals transmitting through electrical wirings between the second electrical element 61 and the terminals 63 can be suppressed to a low level. As a result, the influence of impedance mismatch caused by the terminals 63 that are solder balls, and the like can be reduced, so that the performance of the optical module 1H can be easily improved. As the terminals 63, for example, BGA solder balls can be used instead of microbumps.

FIG. 21 is a cross-sectional view showing an optical module 1J according to a fourteenth modification example. The optical module 1J differs from the optical module 1H in a first sealing member 73 and a wiring configuration. The optical module 1J includes an electrical wiring 71 that is a via, and the electrical wiring 71 extends from the inside of the first airtight space KI to the outside of the first airtight space K1. An area of the first sealing member 73 when viewed along the third direction D3 is wider than an area of the second sealing member 4 when viewed along the third direction D3.

An end portion of the first sealing member 73 in the first direction D1 projects further toward the second electrical element 61 than an end portion of the second sealing member 4 in the first direction D1. Namely, when viewed along the third direction D3, a side wall portion of the first sealing member 73 is located between the side wall portion of the second sealing member 4 and the second electrical element 61. The optical module 1J includes an electrical wiring 72 located inside the first sealing member 73, and the electrical wiring 71 penetrating through the substrate 2 from the electrical wiring 72 in the third direction D3.

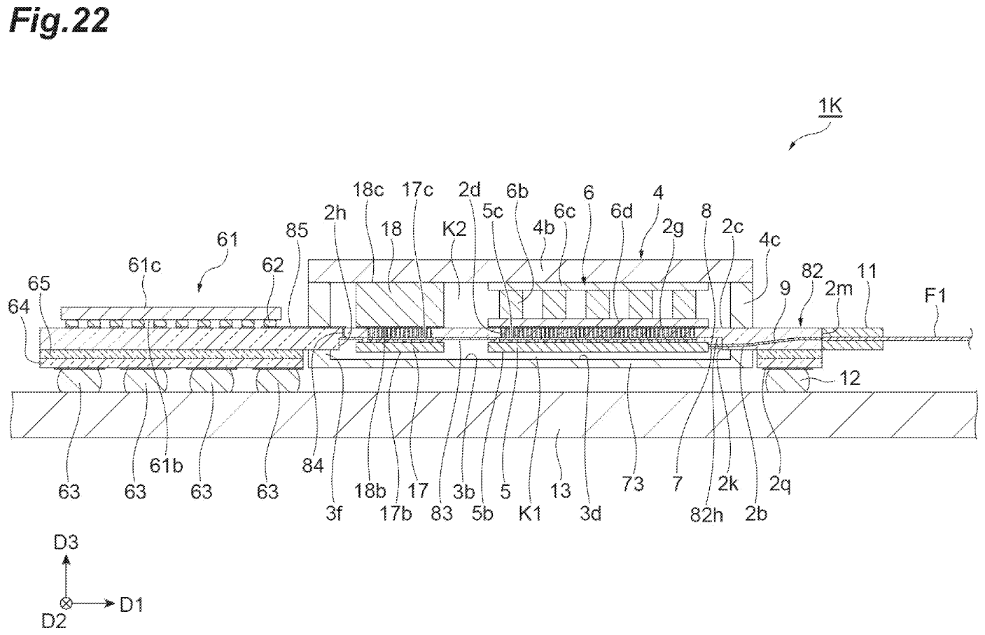

FIG. 22 is a cross-sectional view showing an optical module 1K according to a fifteenth modification example. The optical module 1K differs from the optical module 1H in that the optical element 5 and the electrical element 17 are face-down mounted on a substrate 82. The optical module 1K includes the substrate 82 on which a recessed portion 82h is formed. The optical module 1K includes an electrical wiring 83 that is electrically connected to the electrical element 17 and that extends along a bottom surface of the recessed portion 82h; an electrical wiring 84 that is a TGV penetrating through the substrate 82 from the electrical wiring 83 in the third direction D3; and an electrical wiring 85 extending from the electrical wiring 84 to the outside of the second sealing member 4.

The electrical wiring 85 extends from the second airtight space K2 to the electrode 62 that is electrically connected to the second electrical element 61. By extending the electrical wiring 84 from the electrical wiring 83 extending along the bottom surface of the recessed portion 82h, a length of the electrical wiring 84 can be made shorter than a thickness (a length in the third direction D3) of the substrate 82. As a result, in the optical module 1K, the high-frequency characteristics can be further improved.

The embodiment and various modification examples according to the present disclosure have been described above. However, the present invention is not limited to the embodiment or the various modification examples described above, and can be changed as appropriate within the scope of the concept described in the claims. For example, in the optical modules 1B, 1C, 1D, 1E, IF, 1G, 1H, 1J, and 1K, at least one of the first sealing member 3 and the second sealing member 4 can be omitted depending on the mounting state or the usage environment of components sealed thereinside. For example, when the optical element 5 and the second waveguides 8 can be protected from moisture or a trace amount of gas generated from other components by forming protection films so as to cover the optical element 5 and the second waveguides 8, the first sealing member 3 may be omitted. In addition, for example, when deterioration of the optical element 5 and deterioration of the second waveguides 8 due to moisture, a trace amount of gas generated from other components, or the like are not a problem, the first sealing member 3 may be omitted. Alternatively, when there is no risk of dew condensation on the temperature control element 6, the second sealing member 4 may be omitted. In addition, the optical module according to the present disclosure may be a combination of the embodiment described above and a plurality of examples from the first modification example to the fifteenth modification example. For example, the configuration, shape, size, material, number, and disposition mode of each portion of the optical module according to the present disclosure are not limited to the embodiment or the modification examples described above, and can be changed as appropriate.

What is claimed is:

1. An optical module comprising:
a substrate made of glass and having a first surface, a second surface opposite to the first surface, a via penetrating between the first surface and the second surface, and a first waveguide provided between the first surface and the second surface;
an optical element that is mounted on the first surface, and that inputs and outputs an optical signal;
a thermally conductive member mounted on the second surface and thermally connected to the optical element through the via; and
a second waveguide provided on the first surface,
wherein the optical signal is input to and output from an outside through the second waveguide and the first waveguide.

2. The optical module according to claim 1,
wherein the first surface of the substrate includes a recessed portion,
the optical element is mounted in the recessed portion, and
the second waveguide is provided in the recessed portion.

3. The optical module according to claim 2,
wherein the substrate extends in a first direction and a second direction intersecting the first direction, and has a thickness in a third direction intersecting both the first direction and the second direction,
the second waveguide is optically coupled to the first waveguide through an inner surface of the recessed portion, and
the inner surface is inclined with respect to the second direction.

4. The optical module according to claim 2,
wherein the substrate extends in a first direction and a second direction intersecting the first direction, and has a thickness in a third direction intersecting both the first direction and the second direction,
the second waveguide is optically coupled to the first waveguide through an inner surface of the recessed portion, and
the inner surface is inclined with respect to the third direction.

5. The optical module according to claim 2,
wherein the second waveguide is optically coupled to the first waveguide through an inner surface of the recessed portion, and
an anti-reflection film is provided on the inner surface.

6. The optical module according to claim 1,
wherein the second waveguide is evanescently coupled to the first waveguide.

7. The optical module according to claim 1, further comprising:
an optical fiber,
wherein the first waveguide is optically coupled between the second waveguide and the optical fiber.

8. The optical module according to claim 1,
wherein the first waveguide penetrates between the first surface and the second surface.

9. An optical module comprising:
a substrate made of glass and having a first surface, a second surface opposite to the first surface, a via penetrating between the first surface and the second surface, and a first waveguide provided between the first surface and the second surface;
an optical element that is mounted on the first surface, and that inputs and outputs an optical signal; and
a thermally conductive member mounted on the second surface and thermally connected to the optical element through the via,
wherein the substrate extends in a first direction and a second direction intersecting the first direction, and has a thickness in a third direction intersecting both the first direction and the second direction,
the optical element includes a first lens having an optical axis parallel to the first direction,
the substrate includes a second lens optically coupled to the first lens, and
the optical signal is input to and output from an outside through the first lens, the second lens, and the first waveguide.
